(19) United States
(12) Patent Application Publication
(10) Pub. No.: US 2012/0240950 A1
(43) Pub. Date: Sep. 27, 2012

(54) CIGARETTE MAKING MACHINE TOBACCO CLEANOUT MECHANISM AND TUBE HOLDING DRUM

(76) Inventors: Jacques LAPLANTE, Niles, OH (US); John Joseph Lyda, North Lima, OH (US)

(21) Appl. No.: 13/289,449

(22) Filed: Nov. 4, 2011

Related U.S. Application Data
(63) Continuation-in-part of application No. 13/072,054, filed on Mar. 25, 2011.

(51) Int. Cl. A24C 5/00; B08B 9/027

(52) U.S. Cl. 131/289; 131/108; 15/104.05

(57) ABSTRACT

A cigarette making machine tobacco cleanout mechanism comprising a slide support, a slideable compacting plate disposed on the slide support, a slideable cleanout plate located adjacent the slideable compacting plate, and an engaging mechanism for removeably engaging the slideable compacting plate to the slideable cleanout plate, wherein the slideable cleanout plate is slid by the slideable compacting plate when the slideable compacting plate is slid while removeably engaged to the slideable cleanout plate. Also disclosed is a drum for holding at least one cigarette filling tube and a cleanout container for a cigarette making machine.

### CROSS REFERENCE TO RELATED APPLICATION

This application is a continuation-in-part of U.S. application Ser. No. 13/072,054, filed Mar. 25, 2011, which is incorporated by reference in its entirety.

### FIELD OF INVENTION

This invention relates generally to a cigarette making machine tobacco cleanout mechanism and a cleanout container for a cigarette making machine. This invention also relates generally to a drum for holding at least one cigarette filling tube.

### BACKGROUND OF THE INVENTION

Prior to the invention of the electronic rolling machine, rolling your own cigarettes typically involved manual table top machines, hand held machines, or personal single stick electric machines. These machines often employed a chamber for loading tobacco, a manual lever for compressing tobacco, and a spoon mechanism for injecting tobacco into an empty (preassembled blank cigarette tube. Attempts have been made with varying degrees of success to perfect a table top electric machine that basically employed the same technology, only electronically enhanced. In such machines the spoon mechanism often shreds the tobacco. Loading the proper amount of tobacco each time can be extremely variable. Finally, making cigarettes with such machines can be a slow process.

### SUMMARY OF THE INVENTION

This invention relates to a cigarette making machine tobacco cleanout mechanism comprising a slide support, a slideable compacting plate disposed on the slide support, a slideable cleanout plate located adjacent the slideable compacting plate, and an engaging mechanism for removeably engaging the slideable compacting plate to the slideable cleanout plate, wherein the slideable cleanout plate is slid by the slideable compacting plate when the slideable compacting plate is slid while removeably engaged to the slideable cleanout plate.

This invention further relates to a method of cleaning a cigarette making machine comprising removeably engaging a slideable compacting plate to a slideable cleanout plate, retracting the slideable cleanout plate with the slideable compacting plate, thereby creating a passage between a tobacco conveying device and a discharge area, operating the tobacco conveying device to discharge tobacco from the tobacco conveying device to the discharge area, driving the slideable compacting plate forward, thereby extending the slideabie cleanout plate to a closed position, and disengaging the slideable compacting plate from the slideable cleanout plate.

This invention also relates to a drum for holding at least one cigarette filling tube comprising a first plate with a first face and a second face and having at least one filling tube disposed on the first face, a second plate having a first face and a second face and defining at least one hole, the at least one hole axially aligned with the filling tube, a support structure detachably affixing the first plate to the second plate whereby the first face of the first plate faces the first face of the second plate, and a driven mechanism for rotating the drum communicating with the support structure and having semicircular cutouts and outwardly opening slots.

This invention also relates to a cleanout container for a cigarette making machine comprising a lower bin having an upper end, a lower end and bin sidewalk disposed therebetween, and a bin bottom enclosing the lower end of the bin, a drawer slideably disposed above the lower bin, the drawer having a top, a bottom, and drawer sidewalk disposed therebetween, and a closing portion that at least partially closes the bottom of the drawer, and a scoop having an upper end, a lower end, and scoop sidewalk disposed therebetween, and a bottom enclosing the lower end of the scoop, wherein the scoop is disposed in the top of the drawer.

### BRIEF DESCRIPTION OF THE DRAWINGS

FIG. 1 is a perspective view of a cigarette making machine of the invention.

FIG. 2 is a side view of the tobacco conveying device of FIG. 1.

FIG. 3A is a perspective view of a portion of the cigarette making machine of FIG. 1.

FIG. 3B is an enlarged perspective view of a force multiplying linkage of the invention in the fully extended position.

FIG. 3C is a top view of the force multiplying linkage of FIG. 3B located against a center stop.

FIG. 3D is a side view of the force multiplying linkage of FIG. 3B.

FIG. 3E is a top view of the force multiplying linkage of FIG. 3B with a force input member retracting.

FIG. 3F is a top view of the force multiplying linkage of FIG. 3B in a retracted. position.

FIG. 4 is a partial perspective view of the cigarette making machine of FIG. 1.

FIG. 5 is a perspective view of a pin mechanism of the invention.

FIG. 6A is a perspective view of a filling tube.

FIG. 6B is a side view of another filling tube.

FIG. 7A is a perspective view of a guide head and pin.

FIG. 7B is a side view of another embodiment of the guide head and pin.

FIG. 8A is a section view of a filling tube holding drum.

FIG. 8B is a section view of a filling tube mounted in a drum partially receiving a guide head.

FIG. 8C is a section view of a filling tube mounted in a drum fully receiving a guide head.

FIG. 8D is a section view of a filling tube mounted in a drum fully receiving a guide head showing further a blank cigarette tube being loaded onto the filling tube.

FIG. 8E is a section view of a filling tube mounted in a drum fully receiving a guide head showing further a blank cigarette tube having been fully loaded on the filling tube.

FIG. 8F is a section view of an injection pin injecting a tobacco plug into a filling tube having a blank cigarette tube loaded onto it.

FIG. 8G is a section view of a completed cigarette being ejected from a tilling tube.

FIG. 9 is another partial perspective view of the cigarette making machine of FIG. 1.

FIG. 10 is another partial perspective view of the cigarette making machine of FIG. 1.

FIG. 11 is another perspective view of a pin mechanism.

FIG. 12 is another partial perspective view of a cigarette making machine of the invention.

FIG. 13A is a section view of a collapsible force input member of the invention.

FIG. 13B is a top view of a collapsible force input member connected to an arm and to a force multiplying linkage.

FIG. 14 is a section view of a pin connector of the invention.

FIG. 15A is a perspective view of a linkage support locking device of the invention.

FIG. 15B is a detailed view of a U-shaped pivoting locking portion showing a roller resting against the backside of a linkage support.

FIG. 15C is a detailed view of one embodiment of a distal end of the first leg of the U-shaped pivoting locking portion.

FIG. 15D is a detailed view of another embodiment of a distal end of the first leg of the U-shaped pivoting locking portion.

FIG. 15E is a side view of the linkage support locking device of FIG. 15A.

FIG. 15F is a top view of the linkage support locking device of FIG. 15A showing a roller offset from the backside of the linkage support.

FIG. 16A is a perspective view of a spring-retained linkage support system of the invention with the linkage in the center position.

FIG. 16B is a top view of the spring-retained linkage support system of FIG. 16A with a force input member and a linkage in the retracted position.

FIG. 16C is a top view of the spring-retained linkage support system of FIG. 16A with a force input member in the fully extended position.

FIG. 16D is a top view of the spring-retained linkage support system of FIG. 16A with a linkage in the center position on the return stroke of a force input member.

FIG. 17 is a perspective view of a reduced diameter shaft injection pin of the invention.

FIG. 18 is a perspective view of another embodiment of a cigarette making machine of the invention with some parts omitted for clarity.

FIG. 19A is a perspective view of the embodiment of FIG. 18 with additional parts removed for clarity.

FIG. 19B is a perspective view of the embodiment of FIG. 19A with additional parts removed for clarity.

FIG. 20 is a perspective view of a drum of the invention.

FIG. 21 is a perspective view of an embodiment of the invention showing the Geneva drive mechanism.

FIG. 22 is a perspective view of a cleanout container of the invention.

### DETAILED DESCRIPTION OF THE INVENTION

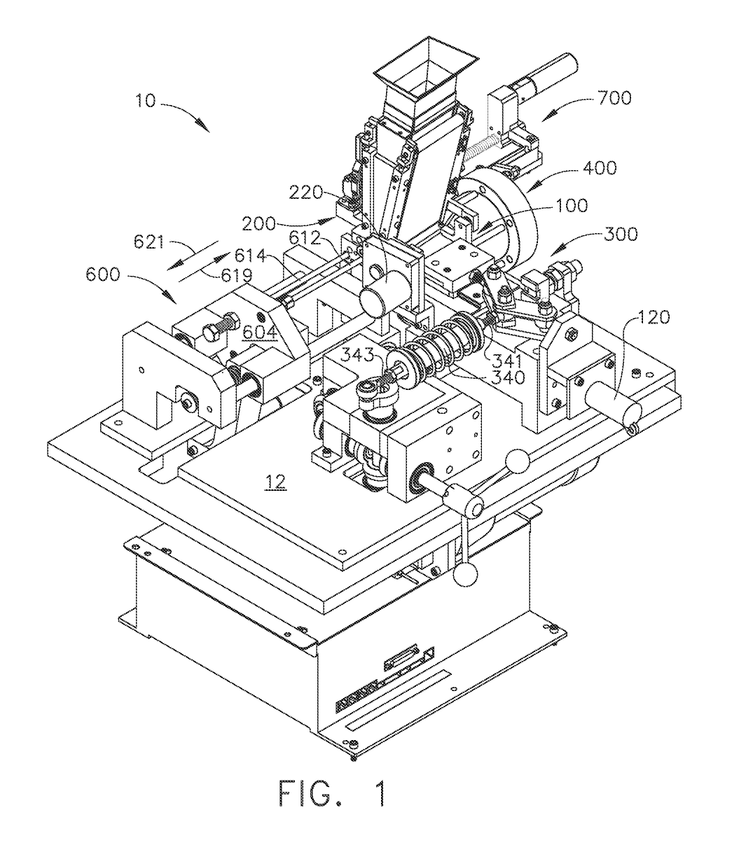

A cigarette making machine 10 is illustrated in FIG. 1. The machine 10 includes a base 12, a tobacco compaction mechanism 100, a tobacco conveying device 200, a force multiplying linkage 300, a filling tube holder 400, a pin mechanism 600, and a blank cigarette tube loader 700.

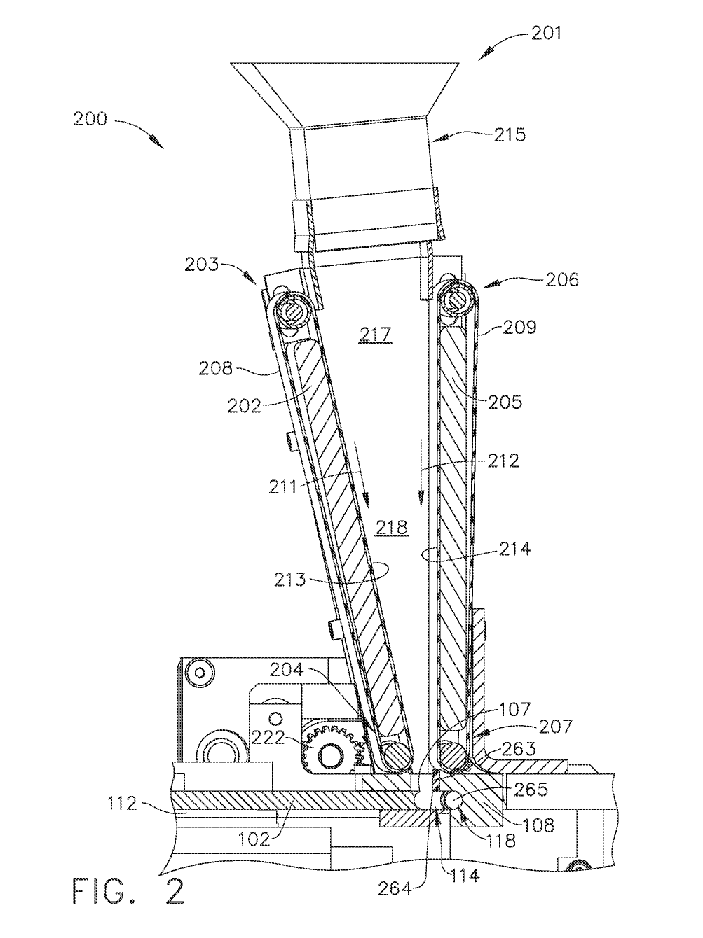

FIG. 2 illustrates the tobacco conveying device 200. The device 200 generally has an input end 201, a receiving hopper 215, a tobacco conveying zone 218, a first conveyor 202 having a top end 203 and a lower end 204, and a second conveyor 205 having a top end 206 and a lower end 207. The conveyors 202 and 205 are mounted between a first side plate 217 and a second side plate (not shown). Conveyor 202 has a conveyor belt 208, and conveyor 205 has a conveyor belt 209. The conveyor belts 208 and 209 may have striations or fingers on them, allowing the moving belts to grip the cut tobacco. The top end 203 of the first conveyor 202 and the top end 206 of the second conveyor 205 communicate with the receiving hopper 215. Typically, the conveyors 202 and 205 converge on each other as they move in the direction of arrows 211 and 212, respectively. At least one electric motor 220 may be used to drive a gear 222 that drives the first conveyor 202 and the second conveyor 205 (see FIGS. 1, 2).

The operation of the cigarette making machine 110 is typically managed by a controller that receives inputs form an operator and various sensors and synchronizes and times the operation of the cigarette making machine. The controller can be a PLC, a microprocessor, a microprocessor on a printed circuit board (PCB), or other controller that is capable of receiving inputs and timing and synchronizing the cigarette machine operation.

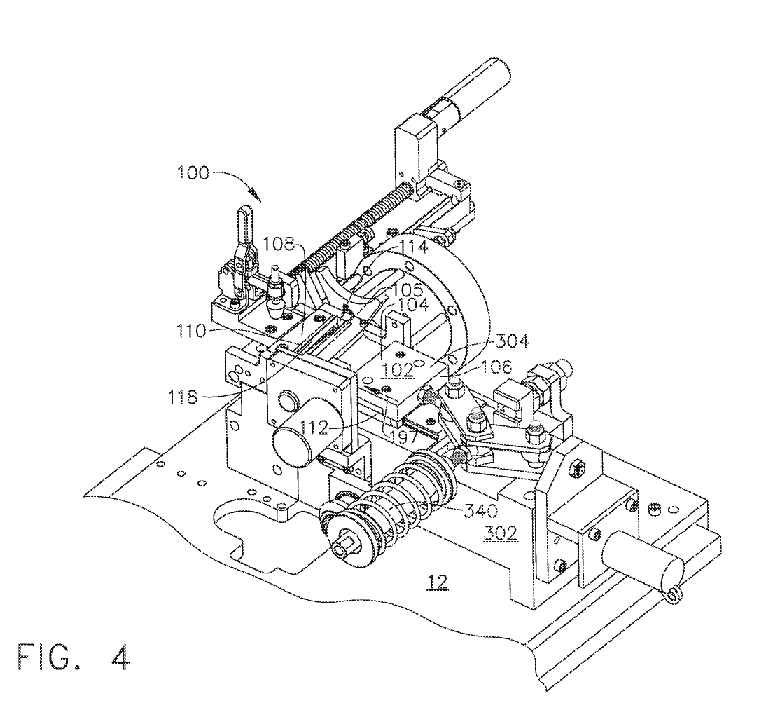

FIG. 4 shows the tobacco compaction mechanism 100 disposed on a base 12. The tobacco compaction mechanism has a force transmitting member 304, which here is a slideable compacting plate 102, with a compacting end 104 and a linkage end 106. The compacting end 104 may also have a compacting die 105. Opposite the slideable compacting plate is a second compacting plate, also referred to as a corresponding compacting plate 108, having a compacting end 110. The corresponding compacting plate may be slideable or it may be fixed. When the slideable compacting plate 102 is retracted as shown in FIG. 4, the compacting end 104 of the slideable compacting plate 102, the compacting end 110 of the corresponding compacting plate 108, and a plate 112 together form a tobacco compaction area 114. When the slideable compacting plate is moved in the direction of arrow 197 to its most distal position, the compacting end 104 of the slideable compacting plate 102 mates with the compacting end 110 of the corresponding compacting plate 108 to form a compacted tobacco cavity 118.

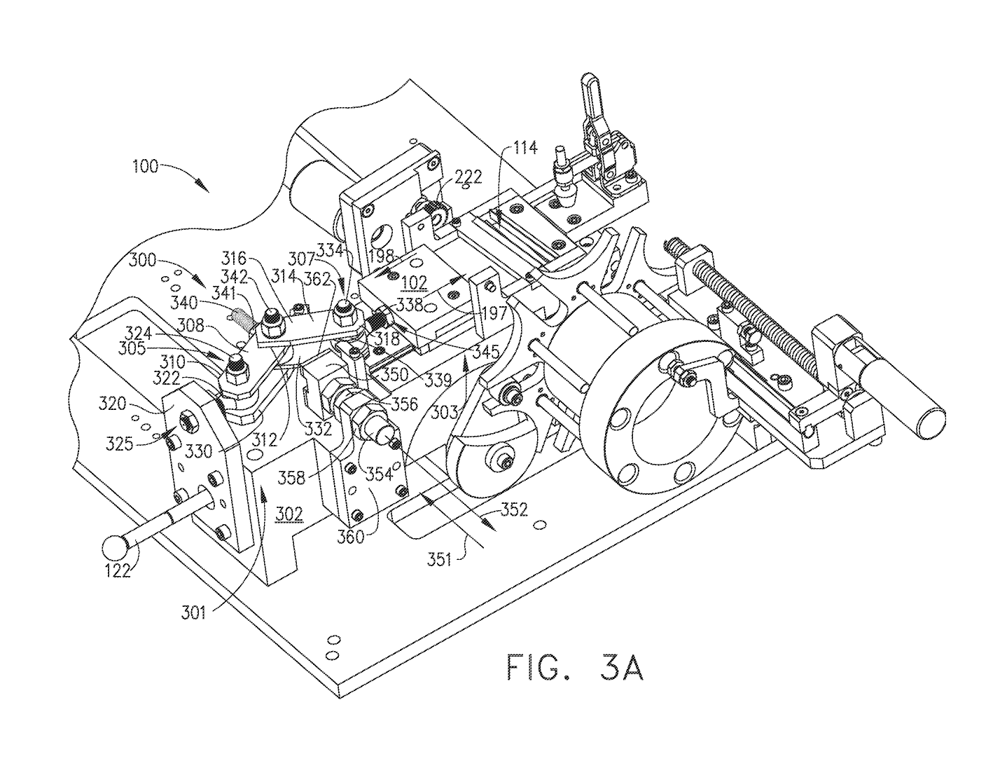

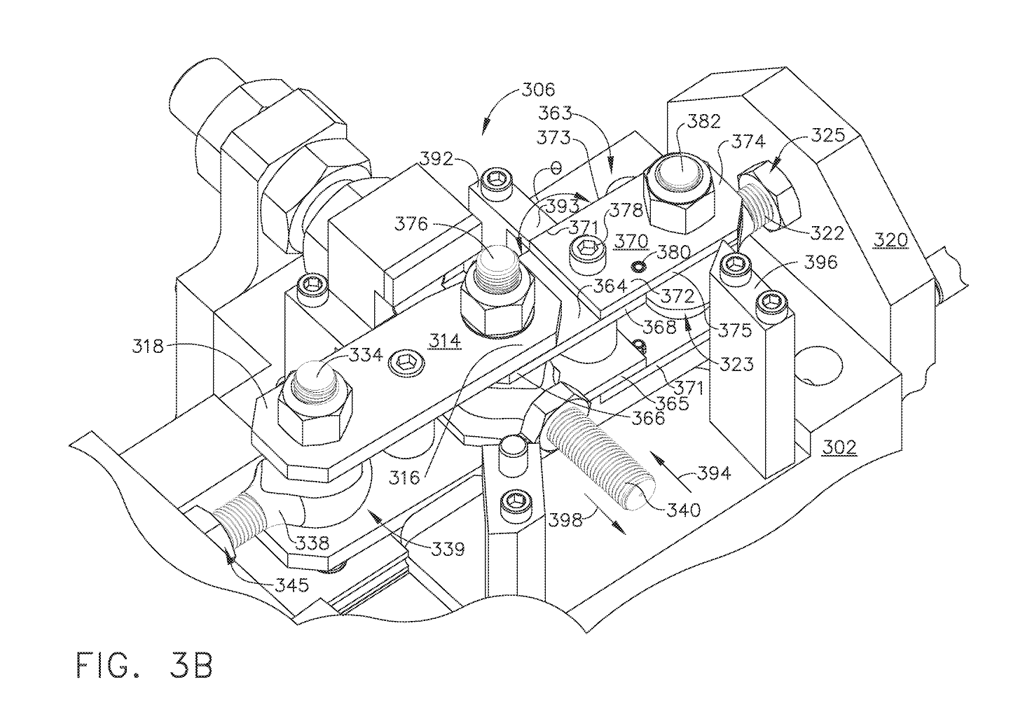

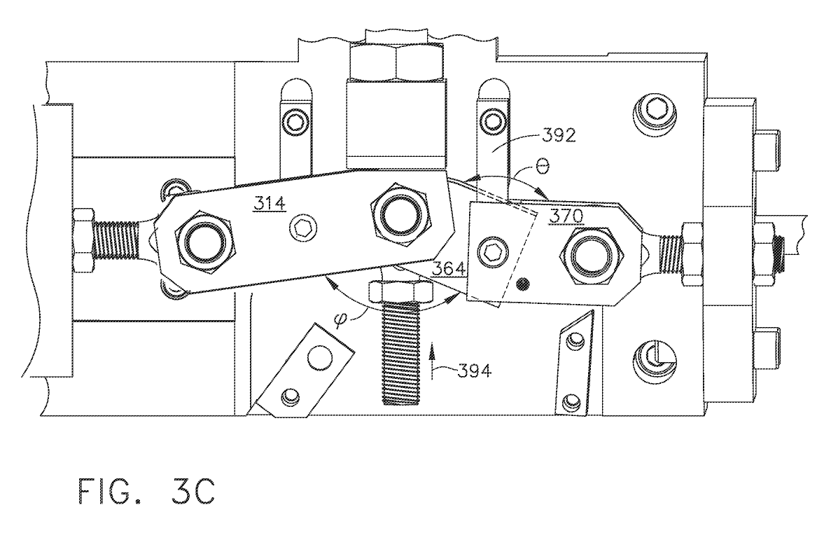

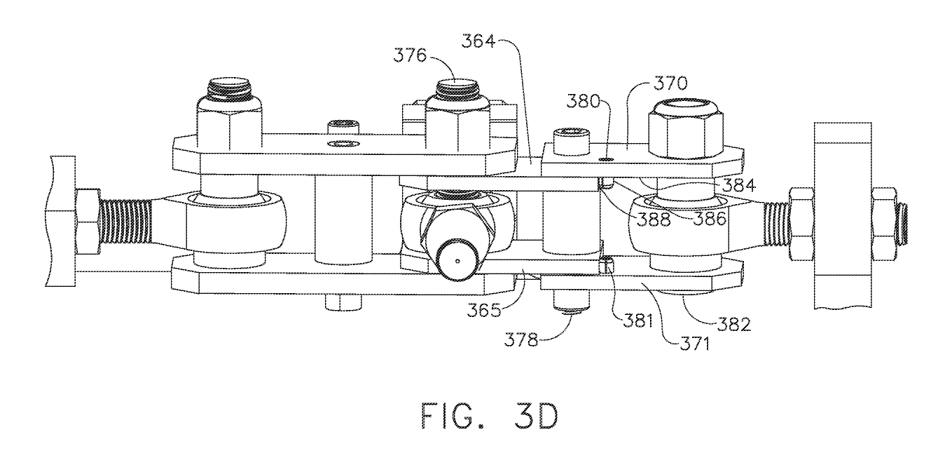

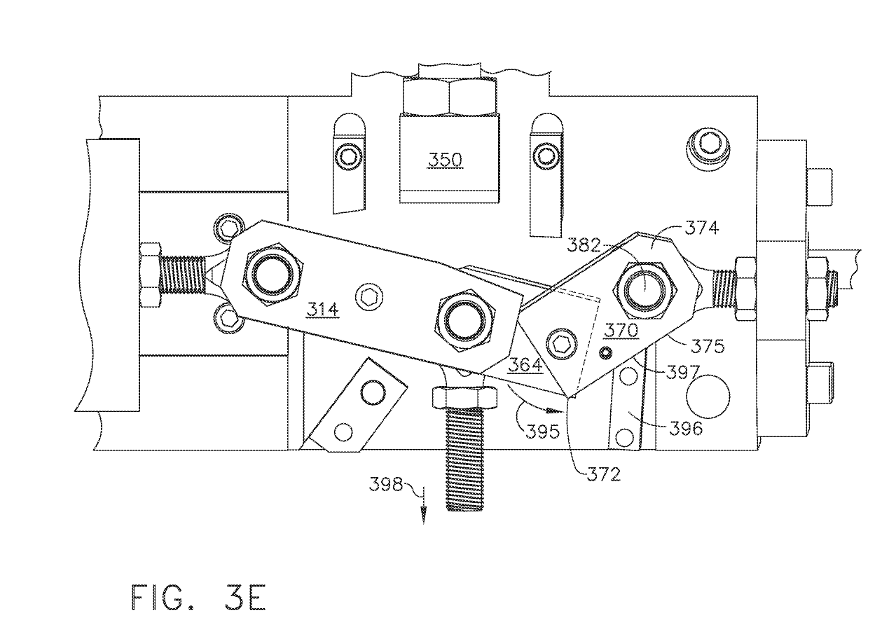

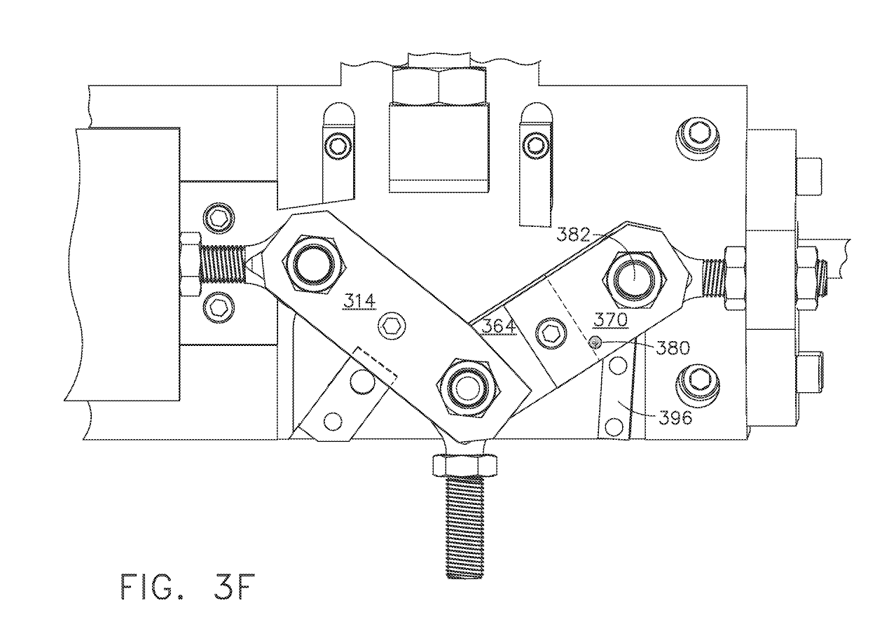

In operation, downwardly moving inner sides 213 and 214 of conveyors 202 and 205, respectively, partially compress cut tobacco and deliver it to the tobacco compaction area 114 (see FIG. 2). The conveyors 202 and 205 run for a period of time to deliver an amount of cut tobacco into the compaction area 114, and then stop. The amount of tobacco that is delivered into the compaction area 114 may be within a predetermined range, with the exact amount being established by the operator of the machine depending on individual preferences, which may include, among other things, the operator's preferred “draw” of the cigarette. Then, a force input member 340 drives the force multiplying linkage 300, which pushes the slideable compacting plate 102 toward the corresponding compacting plate 108, further compacting the tobacco in the compaction area 114 (see FIG. 3A). As the slideable compacting plate 102 moves toward the corresponding compacting plate 108, a top edge 107 of the slideable compacting plate 102 meets a cutting edge 264 of a knife 263 (see FIG. 2). FIG. 2. The cut tobacco in the compaction area 114 is then sheared from the cut tobacco in the tobacco conveying zone 218, thereby forming a tobacco plug 265 in the compacted tobacco cavity 118. Typically, the tobacco plug 265 is smaller in diameter than an inside diameter of a filling tube and a blank cigarette tube to allow for insertion of the tobacco plug into the filling tube and the blank cigarette tube. In one embodiment, a blank cigarette tube is a paper cigarette tube and filter without tobacco.

The plate 112 may also be slideable to allow it to slide away from the compaction area 114, thereby opening the bottom of the compaction area. With a slideable plate 112 open, excess tobacco located in the tobacco conveying zone 218 after a number of cigarettes have been made may be discharged through the compaction area 114 and into an excess tobacco receiving hopper (not shown) located below the compaction area 114. A rod 122 connects the plate 112 to a solenoid 120, which may be used to slide the plate (see FIGS. 1, 3A). Other mechanisms other than a solenoid, such as an electrical linear actuator, a pneumatic cylinder, or a wheel with an offset arm that drives a link, may also be used to slide the plate 112.

As shown in FIG. 3A, the tobacco compaction mechanism 100 has a force multiplying linkage 300 that pushes the slideabie compacting plate 102 and is pivotably attached to a supporting frame 302 by way of a first linkage support 320 and linkage connector 322. The force multiplying linkage has a first end 305, a second end 307, a first force output member 308 that has a first end 310 and a second end 312, and a second force output member 314 that has a first end 316 and a second end 318. The first force output member 308 and the second force output member 314 may each have a corresponding force output member 330 and 332, respectively, to form a double link mechanism. The supporting frame 302 has a first end 301 and a second end 303. The first end 310 of the first force output member 308 is pivotably connected to the first end 301 of the supporting frame 302 by way of a linkage support 320. One method of connecting the first end 310 of the first force output member 308 to the supporting frame 302 and the linkage support 320 is with a first linkage connector 322 having a linkage end 323 and an acting end 325 (see FIG. 3B). Here the first linkage connector 322 is a connecting rod. A pin 324 passes through an eye in the linkage end 323 of the first linkage connector 322 and a hole in the first end 310 of the first force output member 308 to pivotably connect the first linkage connector to the first force output member. The acting end 325 of the first linkage connector 322 is connected to the linkage support 320.

The second end 318 of the second force output member 314 is pivotably connected to a slideable compacting plate 102. One method of connecting the second end 318 of the second force output member 314 to the slideable compacting plate 102 is with a second linkage connector 338 having a linkage end 339 and an acting end 345. Here the second linkage connector is a connecting rod. A pin 334 passes through an eye in the second linkage connector 338 and a hole in the second end 318 of the second force output member 314 to pivotably connect the second linkage connector to the second force output member. The acting end 345 of the second linkage connector 338 is connected to the slideable compacting plate 102.

As shown in FIGS. 1, 3A, a first end 341 of the force input member 340, the second end 312 of the first force output member 308, and the first end 316 of the second force output member 314 are pivotably connected by way of a pin 342 passing through an eye in the force input member 340, a hole in the second end of the first force output member, and a hole in the first end of the second force output member. A second end 343 of the force input member 340 is connected to an arm, described later. A center stop 350 limits the travel of the force input member in the direction shown by arrow 352. The center stop may be adjustable by way of a bolt 354 and nuts 356 and 358 that secure the center stop to a center stop vertical support 360. The stop may also include a pad 362 for cushioning the first force output member and the second force output member as they contact the center stop.

The force multiplying linkage 300 shown in FIG. 3A is in the retracted position. As the force input member 340 moves in the direction of arrow 352, the first end 310 of the first force output member 308 pivots about the pin 324, and the second end 318 of the second force output member 314 moves in the direction of arrow 197. The second end 318 of the second force output member 314 moving in the direction of arrow 197 also moves the slideable compacting plate 102 in the same direction, compacting any tobacco in the compaction area 114. When the pins 324, 342, and 334 become axially aligned the force multiplying linkage is in its folly extended position. Thereafter, continued movement of the force input member 340 in the direction of arrow 352 will cause the pin 342 to go over center, the second end 318 of the second force output member 314 to retract slightly, and the force multiplying linkage 300 to contact the center stop 350.

On the return stroke, the force input member 340 moves in the direction of arrow 351, pulling the force multiplying linkage 300 away from the center stop 350. The second end 318 of the second force output member 314 and the slideable compacting plate 102 will move in the direction of arrow 197 until the pin 342 comes to center and becomes axially aligned with the pins 324 and 334. Continued movement of the force input member 340 in the direction of arrow 351 will cause the second end 318 of the second force output member 314 to move toward the first end 310 of the first force output member 308 in the direction of arrow 198, thereby retracting the slideable compacting plate 102.

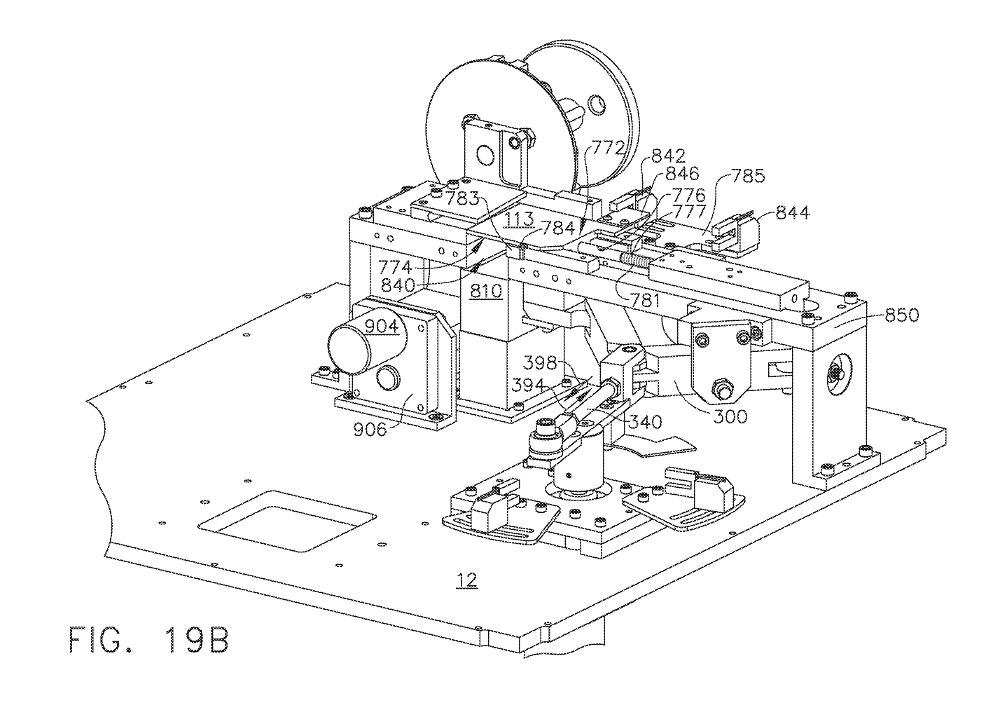

In an embodiment shown in FIG. 18, the tobacco compaction mechanism 100 has the force multiplying linkage 300 located below a slide support 850. The force multiplying linkage 300 that pushes the slideable compacting plate 102 is pivotably attached to a first linkage support 320 by a linkage connector 322. The force multiplying linkage has a first end 305, a second end 307, a first force output member 308 that has a first end 310 and a second end 312, and a second force output member 314 that has a first end 316 and a second end 318. The first end 310 of the first force output member 308 is pivotably connected to the linkage support 320. One method of connecting the first end 310 of the first force output member 308 to the linkage support 320 is with a first linkage connector 322 having a linkage end 323 and an acting end 325 (see FIG. 3B). Here the first linkage connector 322 is a connecting rod. A pin 324 (FIG. 19A) passes through an eye in the linkage end 323 of the first linkage connector 322 and a hole in the first end 310 of the first force output member 308 to pivotably connect the first linkage connector to the first force output member. The acting end 325 of the first linkage connector 322 is connected to the linkage support 320.

The second end 318 of the second force output member 314 is pivotably connected to a slideable support mechanism 851 to which the slideable compacting plate 102 is attached. The slideable compacting plate 102 and the slideable support mechanism 851 are disposed on a slide support 850. The second force output member 314 may be attached to the slideable mechanism in the same manner that the first force output member is connected to the linkage support 320, or other pivotable means and methods of attaching the second force output member 314 to the slideable support mechanism 851 may be used.

As described earlier, the plate 112 may be slideable to allow it to slide away from the compaction area 114, thereby opening the bottom of the compaction area 114. A passage is then created between the tobacco conveying device 200 and a discharge area 840. While removed for clarity in FIG. 19A, the tobacco conveying device 200 is typically located in the area 115, as shown in FIG. 1. Shown in FIG. 19A is a method for sliding a slideable cleanout plate 113 using an engaging mechanism 800 to removeably engage the slideable compacting plate 102 to the slideable cleanout plate 113. In this embodiment, an engaging mechanism 800 for engaging the slideable cleanout plate 113 is located on the upper side 101 of the slideable compacting plate 102. The engaging mechanism 800 has an electrical solenoid 802 with a central pin 804. The central pin is held in the retracted position, as shown in FIG. 19A, by a spring 806 connected to a spring support 808. When energized, the coil of the solenoid 802 drives the central pin 804 downward in the direction of arrow 801.

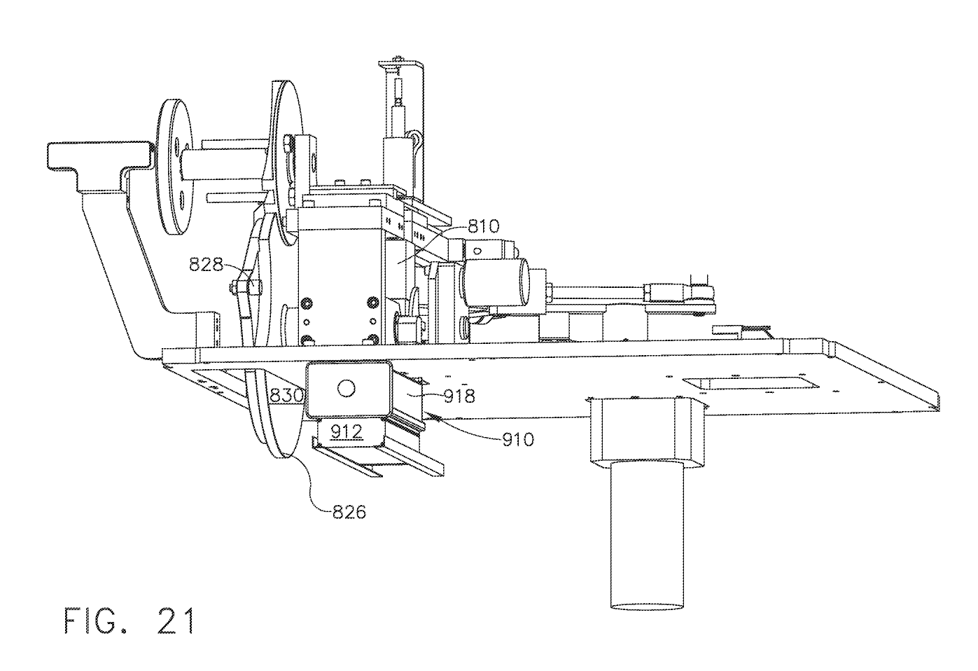

The slideable cleanout plate 113 has a compaction area end 774 and an operated end 772. The operated end 772 has a receiving hole 776. FIG. 19B. The receiving hole 776 may be located in the slideable cleanout plate 113, or it may be located in a member, such as a pin 777, attached to the slideable cleanout plate 113. Typically, during the cigarette making process the slideable cleanout plate 113 remains stationary while the slideable compacting plate 102 compacts tobacco. When the cleanout process is initiated, the slideable compacting plate 102 is moved in the direction of arrow 197 to its most distal position. The solenoid 802 is energized, causing the central pin 804 to project downwardly in the direction of arrow 801 from the solenoid into the receiving hole 776, thereby removeably engaging the slideable compacting plate to the slideable cleanout plate. Thereafter, the force input member 340 retracts in the direction of arrow 398, causing the force multiplying linkage 300 to retract, thereby moving the slideable compacting plate 102 in the direction of arrow 198. Because the central pin 804 is engaged in the receiving hole 776, the slideable cleanout plate 113 is slid by and retracts with the slideable compacting plate 102, thereby moving the slideable cleanout plate 113 to an open position and creating a passage from the tobacco conveying device 200 to the discharge area 840. In this embodiment, a chute 810 is located below the discharge area 840. Thereafter, the tobacco conveying device 200 is operated and the excess tobacco in it is discharged to chute 810 below. The excess tobacco falls through the chute 810 and is collected cleanout container 910 (FIG. 21). When the cleanout process is complete, the force input member 340 moves in the direction of 394, causing the slideable compacting plate 102 and the slideable cleanout plate 113 to move in the direction of 197 and thereby closing the passage between the tobacco conveying device 200 and the discharge area 840. The solenoid 802 is then de-energized to allow the central pin 804 to retract from the receiving hole 776, thereby disengaging the slideable compacting plate from the slideable cleanout plate and allowing the slideable plate to remain in a closed position when tobacco is compacted. Typically, the slideable cleanout plate is held in the closed position by a slideable cleanout plate holding mechanism communicating with the slideable cleanout plate. The slideable cleanout plate holding mechanism could be a spring 281 imparting a force in the direction of arrow 197 on the slideable cleanout plate, a permanent or electric magnet 783 that engages and holds the slideable cleanout plate in the closed position, or a latching mechanism that holds the plate in the closed position. The slideable cleanout plate may be made from a variety of materials, such as ferrous or nonferrous metal or plastic. If a magnet is used and the slideable cleanout plate is made from a nonferrous material, then a ferrous tab 784 may be attached to the slideable cleanout plate to engage the magnet. One or a combination of methods may be used to hold the slideable cleanout plate in a closed position.

Other means and methods of engaging the slideable compacting plate 102 to a slideable plate 112 may also be used, such as a magnet that locks the plates together or a clamp that clamps the plates together.

As shown in FIG. 19B, a first slideable cleanout plate sensor 842 and a second slideable cleanout plate sensor 844 may be slideably mounted to a slotted bar 785 adjacent to the slideable cleanout plate to determine the position of the slideable cleanout plate 113. A slideable cleanout plate sensor actuator 846 is affixed to the slideable cleanout plate 113. When the actuator 846 actuates the first sensor 842 as the slideable cleanout plate reaches a first predetermined position, then a signal is sent to the controller alerting the controller that the slideable cleanout plate is closed. When the actuator 846 actuates the second sensor 844 as the slideable cleanout plate reaches a second predetermined position, then a signal is sent to the controller alerting the controller that the slideable cleanout plate is open, creating a passage from the tobacco conveying device 200 to the discharge area 840.

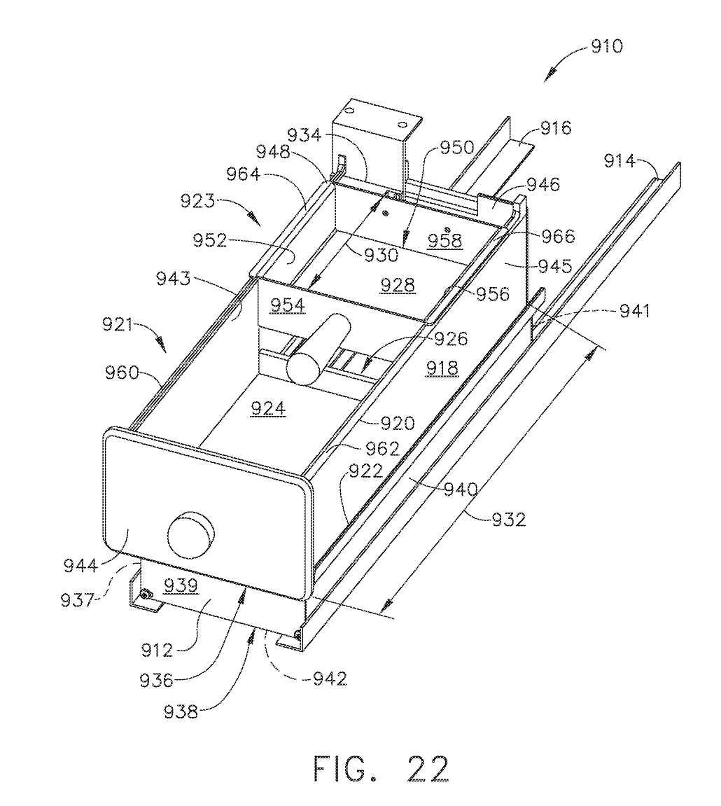

FIG. 21 shows the cleanout container 910 located below the chute 810, and FIG. 22 shows a detailed view of the cleanout container 910. The cleanout container has a lower bin 912 that is held by rails 914 and 916. The lower bin has an upper end 936, a lower end 938, and sidewalk 937, 939, 940, and 941 disposed between the upper end 936 and the lower end 938. A bottom 942 enclosed the lower end 938 of the bin 912.

A drawer 918 having a top 920, a bottom 922, a forward area 921 and a rearward area 923 is slideably disposed on the lower bin 912. Sidewalk 943, 944, 945, and 946 are disposed between the top 920 and the bottom 922 of the drawer 918. The bottom 922 of the drawer has a bottom section 924 that is attached to at least one sidewall and at least partially closes the bottom 922 of the drawer 918. Typically, there is an opening 926 at the bottom 922 that is open to the lower bin 912.

Disposed in the drawer 918 is a scoop 928 with an upper end 948, a lower end 950 and sidewalls 952, 954, 956, and 958 disposed between the upper end 948 and the lower end 950. The top 920 of the drawer 918 has rails 960 and 962 for holding the scoop by way of flange 964 attached to the upper end 948 of the scoop at sidewall 952 and flange 966 attached to the upper end 948 of the scoop at sidewall 956. The scoop 928 has a length 930 that is less than a length 932 of the drawer 918 to allow the scoop to be placed in either the forward area 921 of the drawer or in the rearward area 923 of the drawer. A scoop sensor 934, such as a limit switch, is located to interact with the scoop to determine the position of the scoop 928 in the drawer. The scoop sensor 934 may be located to provide a signal when the scoop is in the rearward area 923 of the drawer 918 and no signal when the scoop is in the forward area 921 of the drawer 918. Alternatively, the scoop sensor may be located to provide no signal when the scoop is in the rearward area 923 of the drawer 918 and a signal when the scoop is in the forward area 921 of the drawer 918. Typically, the sensor communicates with the controller of the cigarette making machine. A sensor interacting with the drawer may also be included to identify the position of the drawer.

Typically, an injection pin (described later) passes through the compacted tobacco cavity 118 when it pushes a tobacco plug 265 out of the compacted tobacco cavity 118 and into a filing tube (FIGS. 1, 4). If the injection pin is in the compacted tobacco cavity when the force input member 340 starts its return stroke, then the injection pin can become pinched between the slideable compacting plate 102 and the corresponding compacting plate 108. Methods available to prevent pinching the injection pin include modifying the size of the injecting pin and preventing the slideable plate from moving in the direction of arrow 197 when the force input member 340 is retracting and moving the force multiplying linkage 300 from its over-center position against the center stop 350 to the fully extended position when the pins 324, 342, and 334 are axially aligned.

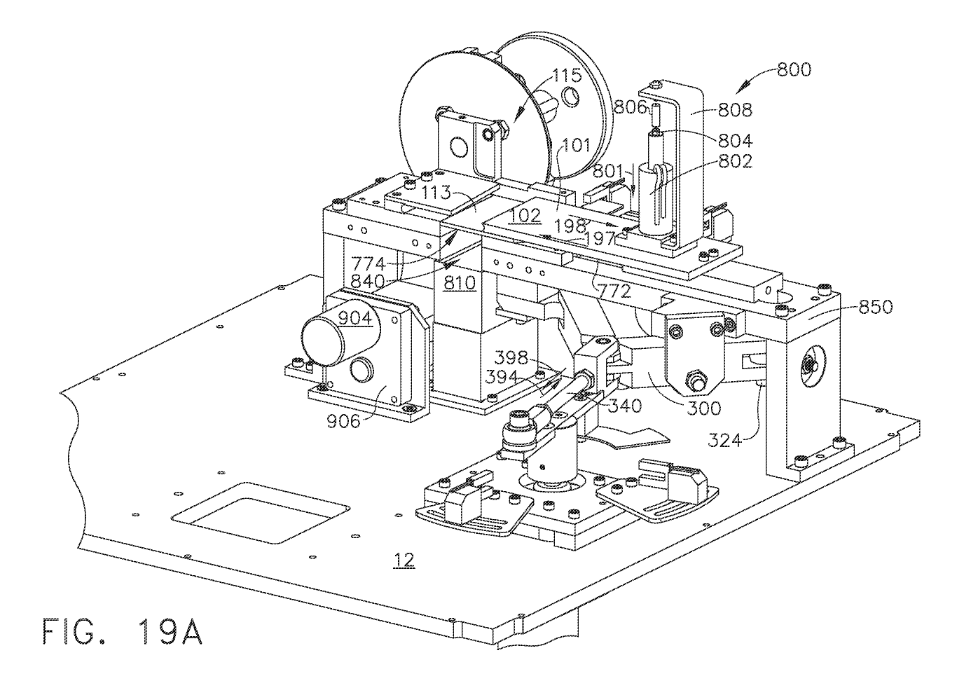

FIG. 17 depicts a reduced diameter shaft injection pin 50 having an acting end 52, a connecting end 54, and a central section 56 disposed therebetween. The acting end 52 has an outside diameter 58 that is approximately the same as the tobacco plug 265 made in the compacted tobacco cavity 118. The connecting end 54 has a ball end 60 sized to fit into a socket, which is described later. The central section 56 that connects the connecting end 54 to the acting end 52 is a reduced diameter shaft that has an outside diameter 57 that is less than the outside diameter 58 of the acting end 52. The reduced diameter of the central section 56 prevents the injection pin 50 from being pinched in the compacted tobacco cavity 118 during the return stroke of the force input member.

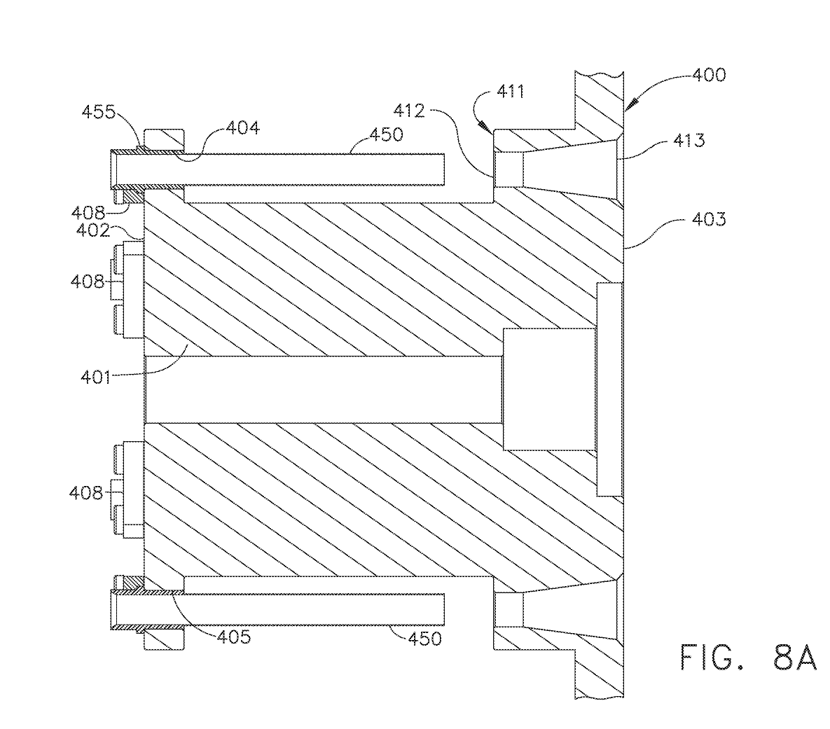

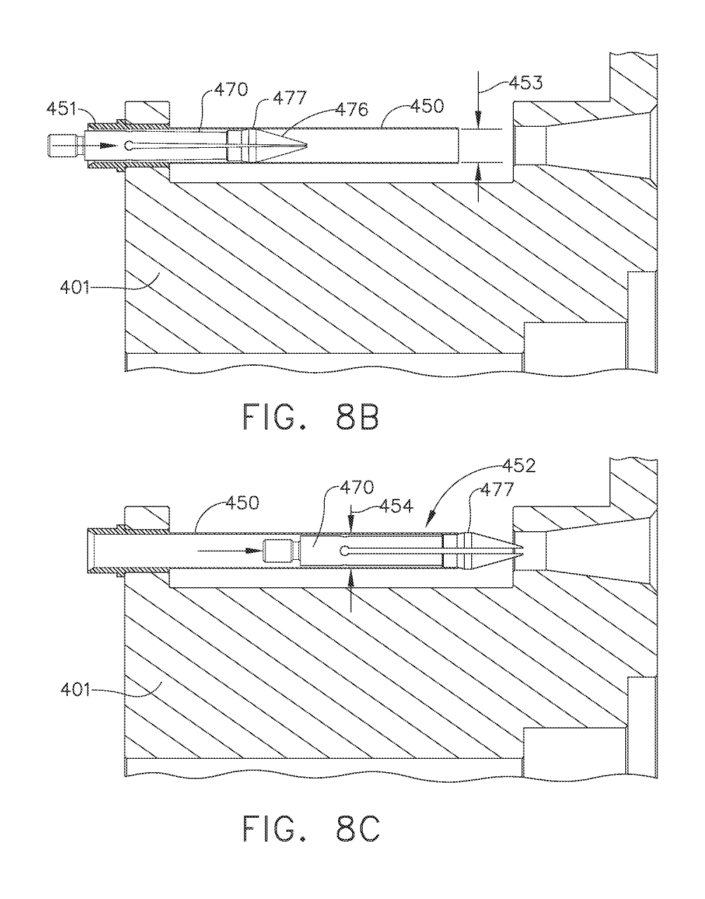

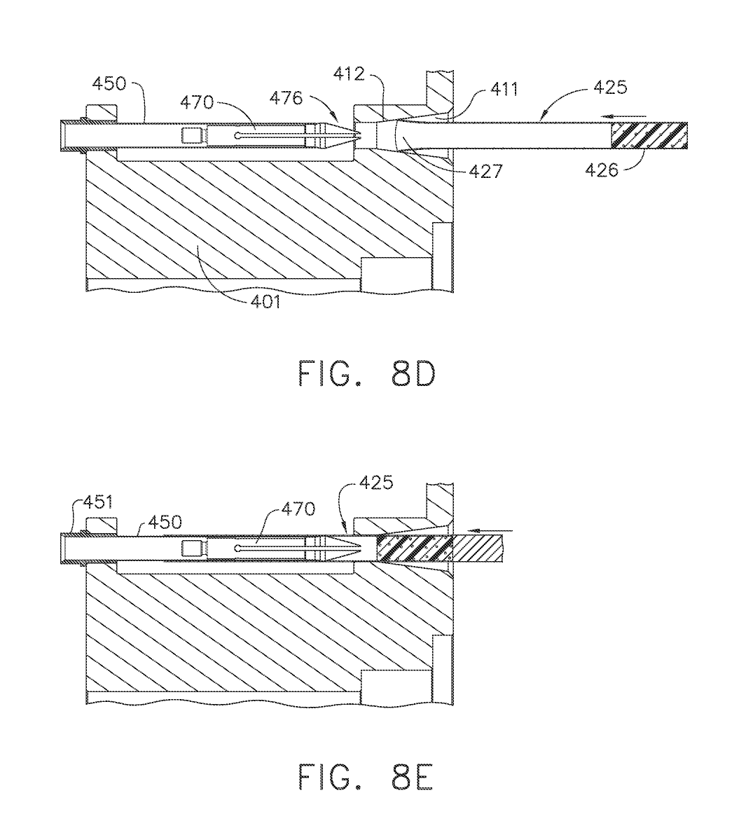

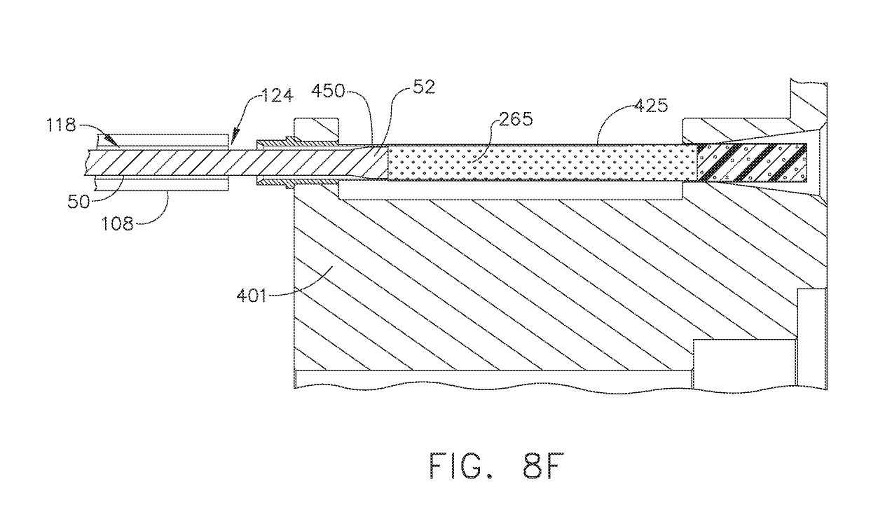

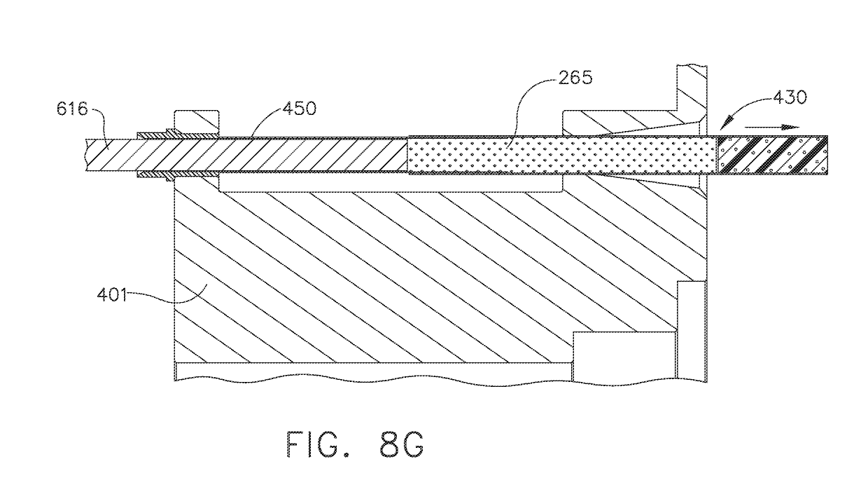

The operation of the reduced diameter shaft injection pin 50 and how it prevents pinching in the compacted tobacco cavity 118 will now be described. FIG. 8F shows the injection pin 50 loading a tobacco plug 265 into a tilling tube 450 having a blank cigarette tube 425 disposed on it. The acting end 52 of the injection pin 50 has passed beyond the compacted tobacco cavity 118, formed in part by the corresponding compacting plate 108, and into the filling tube 450. After the acting end 52 has passed beyond the compacted tobacco cavity 118, the force input member 340 typically begins its return stroke, which causes the slideable compacting plate 102 to move to its most distal position as the force multiplying linkage returns to its fully extended position. If the central section 56 of the injection pin 50 was the same diameter as the acting end 52, as is the case for injection pin 612 shown in FIG. 1, then the injection pin would be pinched in the compacted tobacco cavity 118 between the slideable compacting plate 102 and the corresponding compacting plate 108. The reduced diameter of the central section 56 of the injection pin 50 prevents the injection pin from being pinched.

By the time the injection pin 50 retracts from the filling tube and the acting end 52 reaches a forward end 124 of the compacted tobacco cavity 118, the force input member 340 has retracted the force multiplying linkage off of the center stop 350 and past its fully extended position, and is moving towards its most retracted position. As such, the slideable compacting plate 102 has moved from its most distal position and continues to move in the direction of arrow 198, FIG. 3A, thereby allowing enough room for the acting end 52 to pass through the compacted tobacco cavity 118 without being pinched.

Another way to prevent the slideable compacting plate 102 from pinching an injection pin is to prevent the slideable compacting plate 102 from moving in the direction of arrow 197 during the return stroke by use of a split force output member.

As shown in FIG. 3B, a force multiplying linkage 306 can have a second force output member 314 and a first force output member 363 made from a first link 364 having a first end 366 and a second end 368 and a second link 370 having a first end 372, a second end 374, a first side 373, and a second side 375. The first link 364 may have a lower corresponding link 365 and the second link 370 may have a lower corresponding link 371. FIG. 3B shows the first link 364 and the second link 370 in the fully extended position. A pivotable connector 376 passing through a hole in the first end 316 of the second force output member 314 and a hole in the first end 366 of the first link 364 pivotably connects the first end 366 of the first link 364 to the first end 316 of the second force output member 314. The pivotable connector 376 also pivotably connects the first end 341 of the force input member 340 to the force multiplying linkage. Here, the pivotable connector is a bolt and a nut, but other pivotable connectors, such as pins, may also be used.

The second end 368 of the first link 364 is pivotably connected to the first end 372 of the second link 370 by a pivotable connector 378. Here, the pivotable connector 378 is a bolt, but another pivotable connector, such as a pin, may also be used. The second end 374 of the second link 370 is pivotably connected to the first linkage connector 322 by a pivotable connector 382 passing through an eye in the linkage end 323 of the first linkage connector 322 and through a hole in the second end 374 of the second link 370. The acting end 325 of the first linkage connector 322 is connected to the linkage support 320. Here, the pivotable connector 382 is a bolt, but another pivotable connector, such as a pin, may also be used.

As shown in FIGS. 3B and 3D, a first stop 380 is affixed to the second side 375 of the second link 370. Here, the first stop 380 is a stop pin that is affixed to the second link 370 and passes through the second link 370. A portion 386 of the first stop 380 extends beyond a lower surface 384 of the second link 370. A second stop pin 381 may be included in the lower corresponding link 371. An outer angle theta is defined by the first link and the second link. When the first link 364 and the second link 370 are in the fully extended position, a lower portion 386 of the first stop 380 rests against the second end 368 of the first link 364 at a stop point 388, thereby limiting the angle theta. Typically the angle theta is limited to between 150 and 210 degrees, more typically between 160 and 200 degrees, more typically between 170 and 190 degrees, more typically between 175 and 185 degrees, and most typically between 178 and 183 degrees. FIG. 3B shows an angle theta that is approximately 180 degrees.

A first travel limiter 392 is positioned adjacent the center stop 350 and stops the pivoting travel of the second link 370 about the pivotable connector 382 and the first linkage connector 322. The pivoting travel is stopped when a front end 393 of the first travel limiter 392 contacts the first side 373 at the front end 372 of the second link 370 at an approximate location. 369 while the force input member 340 is moved in the direction of arrow 394. Typically, the first travel limiter stops the pivoting travel of the second link 370 about the pivotable connector 382 when the pivotable connectors 376, 378, and 382 are aligned, resulting in the first end 366 of the first link 364 and the second link 370 being at their folly extended position, creating an angle theta of 180 degrees. But the first travel limiter may stop the pivoting of the second link at other positions also.

FIG. 3C shows that as the force input member continues to move in the direction of arrow 394 after the second link 370 has been stopped by the first travel limiter 392, the angle theta between the first link 364 and the second link 370 is reduced. Here, the angle theta becomes less than 180 degrees. Additionally, an angle phi that was 180 degrees when the second force output member 314, the first link 364 and the second link 370 were in there fully extended positions, becomes less than 180 degrees as shown in FIG. 3C. With the angles theta and phi less than 180 degrees, the first link 364, second link 370 and second force output member 314 are not at their fully extended positions and the slideable compacting plate 102 has retracted from its most distal position.

When the force input member 340 retracts, the first link 364 and the second link 370 remain pivoted at an angle theta of less than 180 degrees. And because they are free to pivot inwardly more, the angle theta may be further reduced. As such, the first force output member 308, the first link 364, and the second link 370 do not return to their fully extended position during the return stroke of the force input member 340. Thus, the slideable compacting plate 102 does not move to its most distal position during the return stroke of the force input member 340, thereby preventing it from binding an injection pin in the compacted tobacco cavity 118.

FIG. 3E shows that during the return stroke of the force input member, the second link 370 encounters a second travel limiter 396, which limits the pivoting travel of the second end 374 of the second link 370 on the pivot 382. As a face 397 of the second travel limiter 396 interacts with the second side 375 of the second link 370, the pivoting travel is stopped. As the force input member continues to retract in the direction of arrow 398, the first link 364 rotates in the direction of arrow 395 until the lower portion 386 of the first stop 380 rests against the second end 368 of the first link 364 at a stop point 388. The force input member is then typically in a fully retracted position as shown in FIG. 3F.

Instead of the first force output member having a first and second link to prevent the slideable compacting plate 102 from moving in the direction of arrow 197 during the return stroke of the force input member 340, the second force output member 314 may have a first and second link operating in a manner similar to the first and second link of the first force output member. Additionally, both the first force output member and the second force output member may each have a first and second link to prevent the slideable compacting plate 102 from moving in the direction of arrow 197 during the return stroke of the force input member 340.

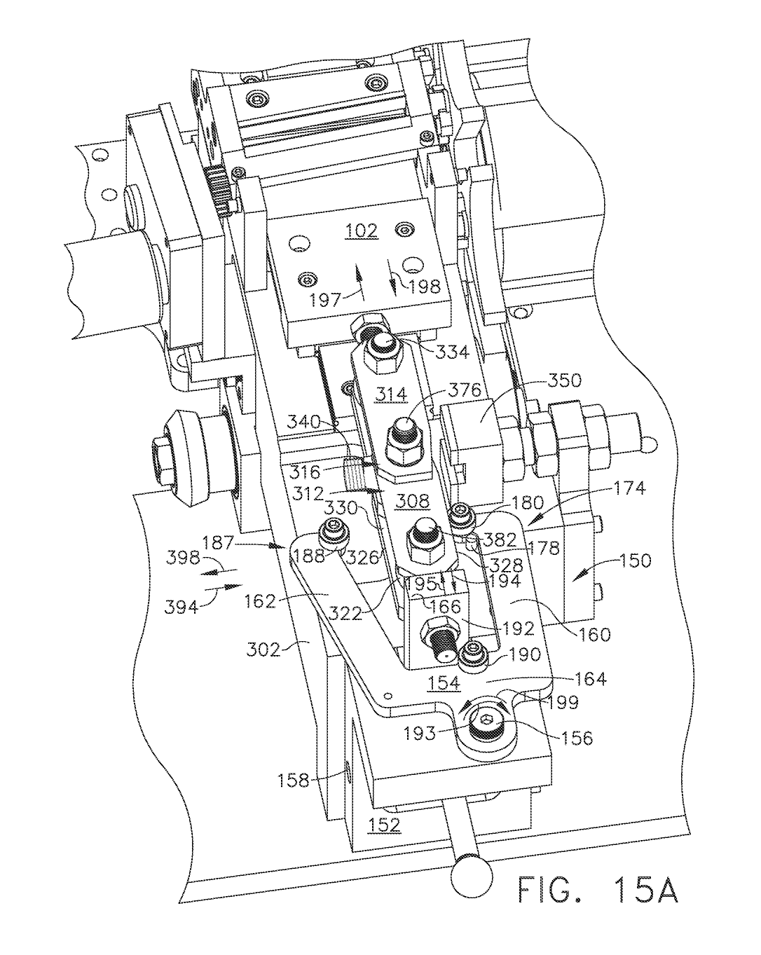

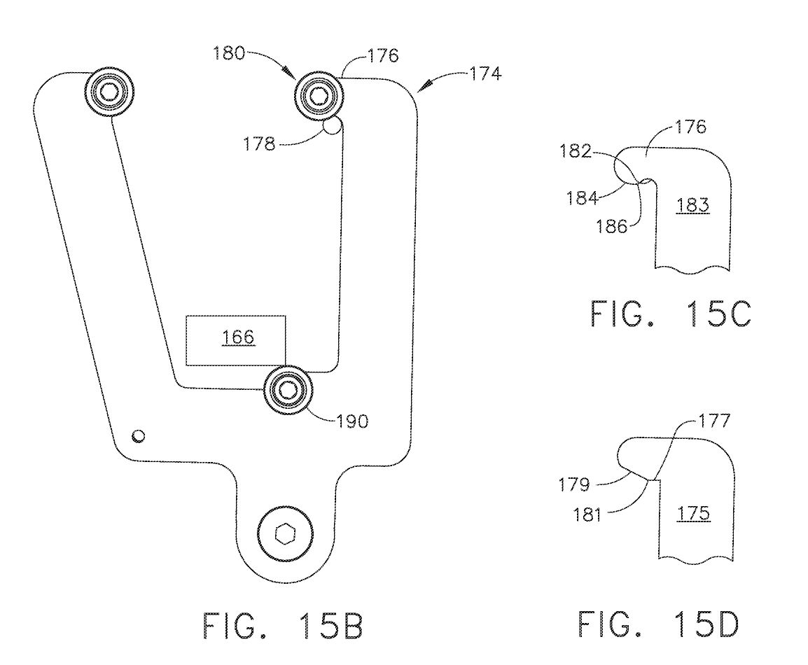

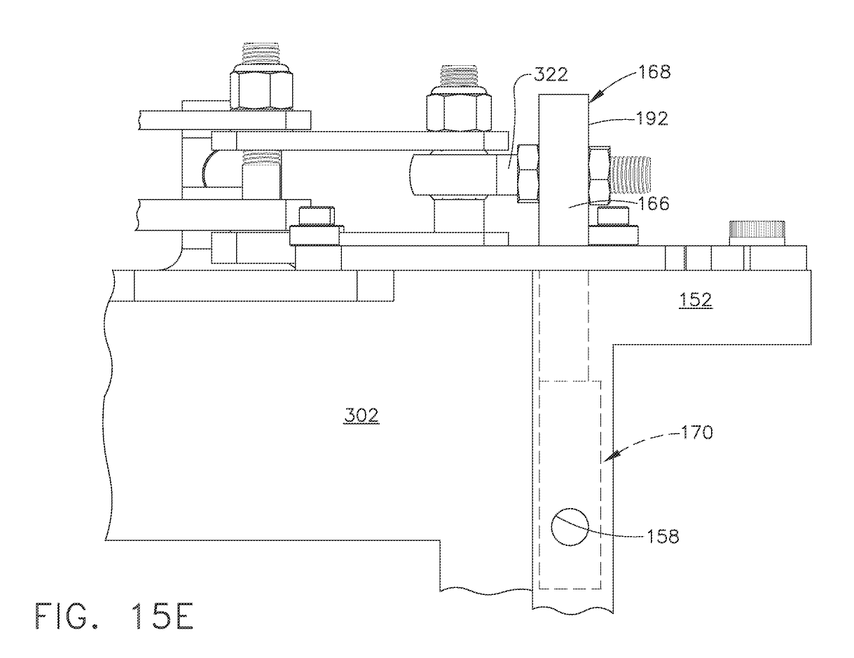

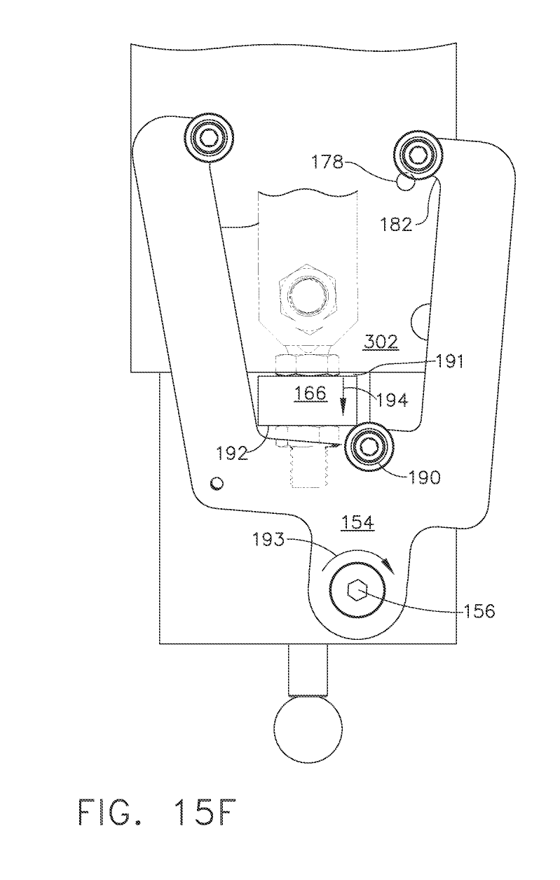

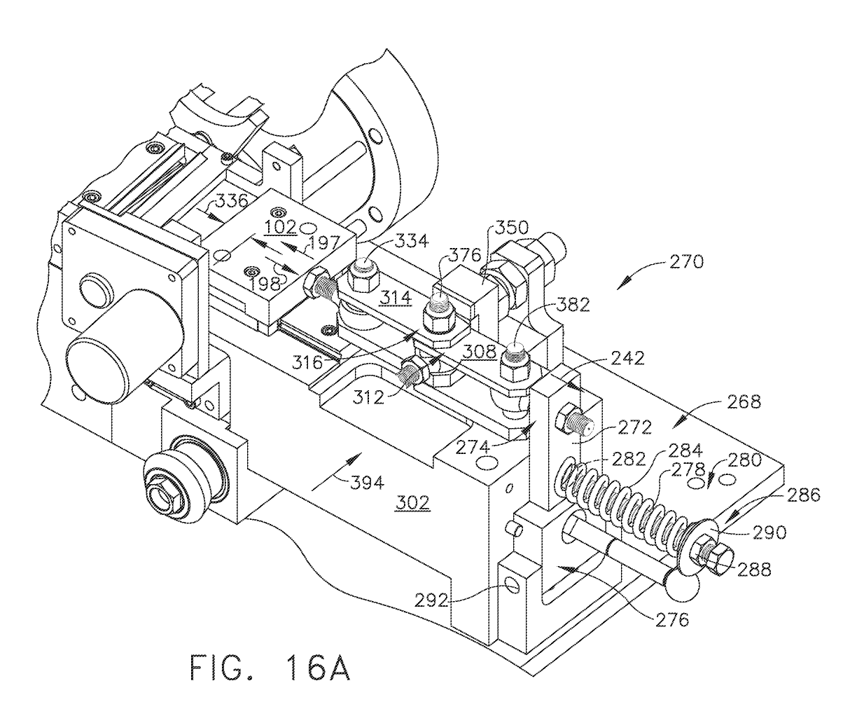

FIGS. 15A through 15F show another way that the first force output member 308 and the second force output member 314 may be configured to prevent the slideable compacting plate 102 from moving in the direction of arrow 197 during the return stroke of the force input member 340. A linkage support locking device 150 having a U-shaped pivoting locking portion 154 with an end section 164 is pivotably mounted to the supporting frame 302 by way of a supporting flange 152 with a pivot pin 156.

The U-shaped pivoting locking portion 154 has a first leg 160 and a second leg 162 that straddle the first force output member 308 and a linkage support 166. The first leg 160 is adjacent to a first side 328 of the force multiplying linkage and the second leg 162 is adjacent to a second side 326 of the force multiplying linkage. The linkage support 166 has an upper end 168 that is connected to the first force output member 308 by way of the first linkage connector 322 and a tower end 170 that is hingeably connected to the supporting frame by hinge 158. A distal end 174 of the first leg 160 has a hook 176 that locks about a pin 178 mounted in the supporting frame 302 and a roller 180 that is coplanar with the corresponding link 330 and interacts with the first side 328 of the force multiplying linkage (see FIGS. 15A, 15B). One embodiment of a hook 176 is shown by portion 183 and has a pin receiving portion 182 for receiving the pin 178 and an inclined portion 184 (see FIG. 15C). The pin receiving portion 182 may be semicircular with a knob 186 for holding the pin 178. Another embodiment of the hook is shown by portion 175 in FIG. 15D. Here, the hook has an inclined portion 179, a knob or transition point 181, and a pin receiving portion 177.

Referring back to FIG. 15A, a distal end 187 of the second leg 162 has a roller 188 that is coplanar with the corresponding link 330 and interacts with the second side 326 of the force multiplying linkage. The end section 164 of the U-shaped pivoting locking portion 154 has a roller 190 that interacts with the linkage support 166.

When the force input member 340 is in a fully retracted position, the second side 326 of the force multiplying linkage rests against the roller 188, and the pin 178 is located in the pin receiving portion 182. The roller 190 interacts against a backside 192 of the linkage support 166, preventing the linkage support 166 from moving in the direction of arrow 194.

As the force input member 340 moves in the direction of arrow 394, the first force output member 308 and the second force output member 314 push the slideable compacting plate 102 in the direction of arrow 197 and arrive in their fully extended position where the pins 376, 334, and 382 are aligned and the pin 376, the second end 312 of the first force output member 308, and the first end 316 of the second force output member 314 are in the center position. The fully extended position of the first force output member 308 and the second force output member 314 also correspond to the slideable compacting plate 102 being at its most distal position, thereby fully compacting the tobacco in the compacted tobacco cavity 118.

As the force input member 340 continues to move in the direction of arrow 394, the pin 376, the second end 312 of the first force output member 308, and the first end 316 of the second force output member 314 move over center towards the center stop 350. As the pin 376, second end 312, and first end 316 move over center, a first side 328 of the force multiplying linkage 300 contacts the roller 180. Also, once the pin 376, second end 312, and first end 316 move over center, they pull the slideable compacting plate in the direction of arrow 198 away from its most distal position. Continued motion of the force input member 340 in the direction of arrow 394 causes the first side 328 of the force multiplying linkage 300 to push against the roller 180, pivoting the U-shaped pivoting locking portion 154 about the pivot 156, and disengaging the pin 178 from the pin receiving portion 182. As the U-shaped pivoting locking portion 154 pivots in the direction of arrow 193, the roller 190 moves away from. backside 192 of the linkage support 166. The linkage support 166 is then free to pivot about the hinge 158 and move in the direction of arrow 194.

FIG. 15F shows the U-shaped pivoting locking portion 154 pivoted about the pivot 156 in the direction of arrow 194. Also shown is pin receiving portion 182 having moved away from the pin 178 and the roller 190 having moved away from the backside 192 of the linkage support 166, thereby allowing the linkage support to pivot in the direction of arrow 194. A gap 191 can then be observed between the linkage support 166 and the supporting frame 302.

As the force input member 340 moves in the direction of arrow 398 on the return stroke, the pivoting action of the linkage support 166 in the direction of arrow 194 allows the slideable compacting plate 102 to maintain its current position rather than returning to its most distal position when the first force input member 308 and the second force input member 314 are in their most extended positions. Thus, pivoting action of the linkage support 166 prevents the slideable plate from pinching the injection pin.

As the force input member 340 continues retracting in the direction of arrow 398, the second side 326 contacts the roller 188. Continued motion of the force input member 340 in the direction of arrow 398 causes the second side 326 of the corresponding force output member 330 to push the roller 188, and thus the distal end 187 of the second leg, in the direction of arrow 398. The U-shaped pivoting locking portion 154 then pivots about pivot 156 in the direction of arrow 199, causing the roller 190 to push the linkage support 166 in the direction of arrow 195 as it moves back against the backside 192 of the linkage support 166. When the force input member 340 reaches its retracted position, the pin 178 rests in the pin receiving portion 182 and the roller 190 rests against the backside 192 of the linkage support 166, preventing it from moving in the direction of arrow 194 during the next forward stroke of the force input member.

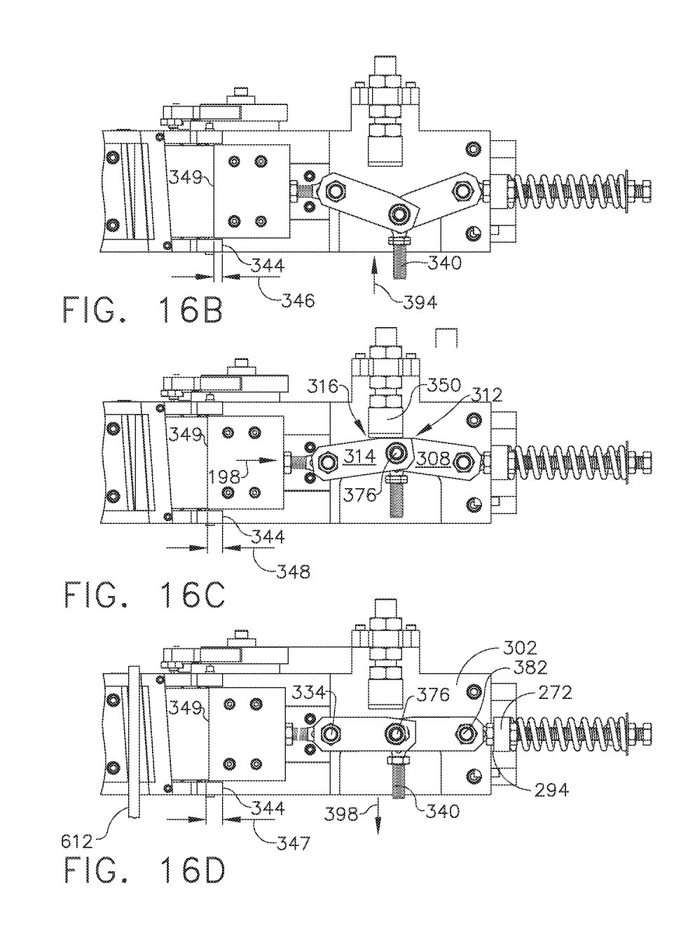

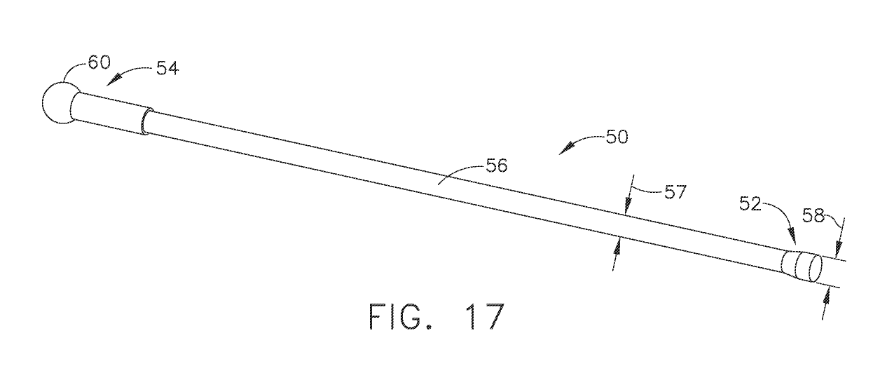

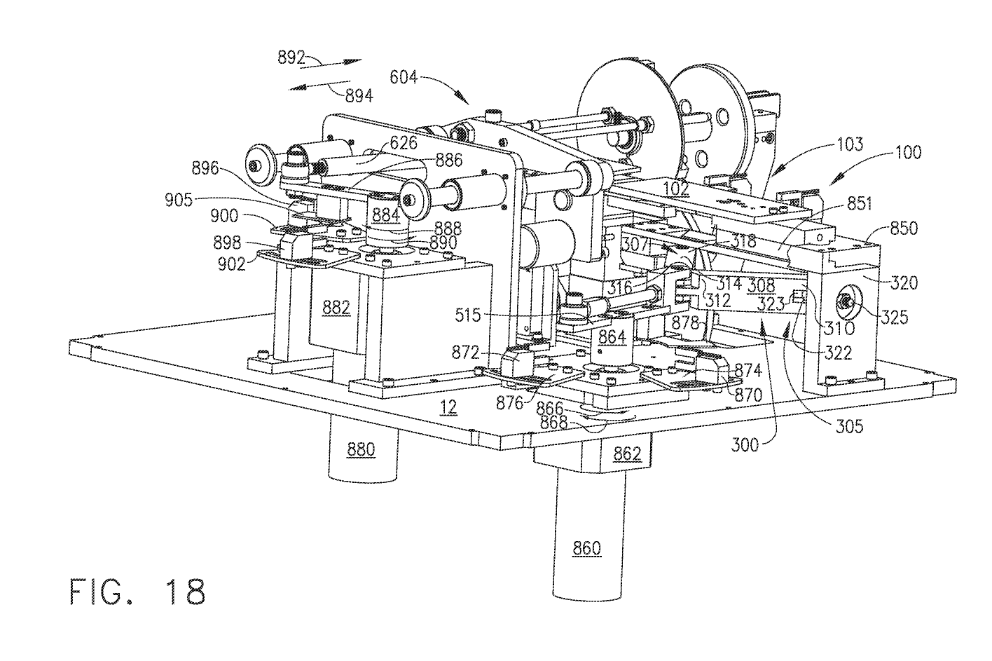

FIG. 16A shows another type of mechanism that may be used to prevent the slideable compacting plate 102 from pinching an injection pin in the compacted tobacco cavity 118 on the return stroke of the force input member 340. A spring-retained linkage support system 270 has a hinged linkage support 272 with a linkage end 274 and a hinged end 276. The hinged end 276 is pivotably connected to the supporting frame 302 by a hinge 292. A spring holder 268 has a rod 278 having a distal end 286 with a spring retainer 280 and an opposite end that passes through a hole 282 in the hinged linkage support 272 and is affixed to the supporting frame 302. Here, the rod is threaded into the supporting frame 302, but other methods of affixing the rod to the supporting frame, such as welding, may also be used. The spring retainer 280 biases a spring 284 against the hinged linkage support 272.

The spring retainer 280 has a nut 288 and a washer 290. The pressure the spring exerts on the hinged linkage support 272 may be adjusted by way of threading the nut 288 in or out on the threaded distal end 286 of the rod 278.

In FIG. 16B, the force input member 340 is shown in a fully retracted position. in the fully retracted position, the distance between a reference point 344 and a front edge 349 of the slideable compacting plate 102 is shown as 346. As the force input member 340 moves in the direction of arrow 394, the first force output member 308 and the second force output member 314 push the slideable compacting plate 102 in the direction of arrow 197 and arrive in their hilly extended position where the pins 376, 334, and 382 are aligned and the pin 376, the second end 312 of the first force output member 308, and the first end 316 of the second force output member 314 are in the center position (see FIG. 16A). The fully extended position of the first force output member 308 and the second force output member 314 also correspond to the slideable compacting plate 102 being at its most distal position with a distance 336 being greater than the distance 346, thereby compacting the tobacco into a tobacco plug. The spring 284 exerts sufficient pressure on the hinged linkage support 272 to compact the tobacco in the compacted tobacco cavity 118 before the hinged linkage support 272 pivots away from the supporting frame in the direction of arrow 242.

As the force input member 340 continues to move in the direction of arrow 394, the pin 376, the second end 312 of the first force output member 308, and the first end 316 of the second force output member 314 move over center towards the center stop 350. As shown in FIG. 16C, once the pin 376, second end 312, and first end 316 move over center, they pull the slideable compacting plate in the direction of arrow 198 away from its most distal position, resulting in a distance 348 being less than the distance 336. The pin 376, the second end 312 of the first force output member 308, and the first end 316 of the second force output member 314 then rest against the center stop 350.

FIG. 16D shows the fully extended position of the force multiplying linkage when the force input member 340 is on its return stroke. Concurrently, an injection pin 612 has moved into the compacted tobacco cavity 118 to inject a tobacco plug into a filling tube (not shown). As the force multiplying mechanism moves to the fully extended position, the slideable compacting plate 102 moves against the injection pin 612. When the slideable compacting plate 102 hits the injection pin 612, spring 284 compresses to allow the hinged linkage support 272 to pivot away from the supporting frame 302 on the hinge 292 so that the slideable compacting plate 102 does not bind the injection pin in the compacted tobacco cavity. A gap 294 shows that the hinged linkage support 272 has pivoted away from the supporting frame 302. Typically a distance 347 is less than the distance 336 by an amount equal to a gap 294 between the supporting frame 302 and the hinged linkage support 272. As the force input member 340 continues to move in the direction of arrow 398, the slideable compacting plate 102 pulls away from the injection pin 612 and the spring biases the hinged linkage support 272 against the supporting frame 302.

FIG. 1 shows a pin mechanism 600 affixed to the base 12. As shown in FIG. 5, the pin mechanism 600 has a pin carrier support structure 602 having slide receivers 605 and 606 and slides 607 and 609. Slides 607 and 609 are affixed to a vertical portion 611 of the pin carrier support structure 602. A slideable pin carrier 604 having slide receivers 620 and 622 and slides 608 and 610 is slideably mounted to the pin carrier support structure 602 by way of slides 608 and 610 passing through slide receivers 605 and 606 and slides 607 and 609 passing through slide receivers 620 and 622.

Arm 626 connects a drive pin 624 to a pin 628 that is offset a distance from the center of a wheel 630 by arm 625. As the wheel 630 rotates, the rotational motion is converted to a linear motion by arm 626, thereby driving the slideabie pin carrier 604 back and forth as shown by double arrow 632.

The slideable pin carrier 604 has a plurality of pins, including an injection pin 612, a guide pin 614 having a guide head 615, an ejection pin 616, and a cleaning pin 618. The slideable pin carrier may have more or less pins, depending on the needs of the tobacco making machine. Typically, during operation, the injection pin 612 is aligned with the compacted tobacco cavity 118.

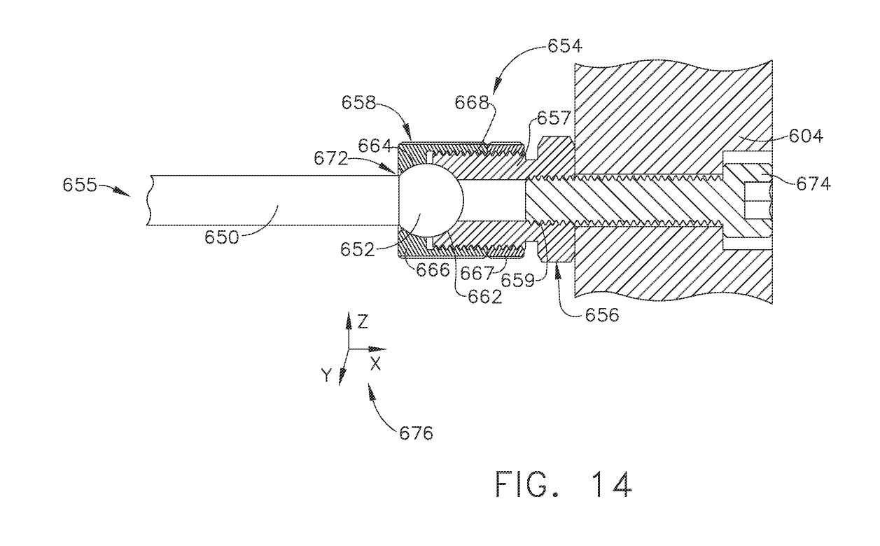

The pins typically slide through the filling tubes, and as they do so they may rub against the sides of the filling tubes if they are too rigid. One way to reduce friction between the pins and the filling tubes is to allow the pins to pivot on the slideable pin carrier. One apparatus utilizes a ball and socket joint to allow the pins to pivot. FIG. 14 shows a connector 654 having a mounting end 656 and a connecting end 658. The connecting end 658 includes a nut 666, a locknut 667, a male-threaded portion 657 for receiving the nut 666, and a first semicircular portion 662. The nut 666 has female threads 668 and a second semicircular portion 664. The first semicircular portion 662 and the second semicircular portion 664 define a socket 672 in the connecting end. The mounting end 656 contains female threads 659 for receiving a bolt 674 which affixes the connector 654 to the slideable pin carrier 604. Other methods of affixing the mounting end 656 of the connector 654 to the pin carrier may also be used.

FIG. 14 shows a representative pin 650 having an acting end 655 and a connecting end 652. Depending on the configuration of the acting end of the pin, the pin may be a guide pin 614, an injection pin 612, a cleaning pin 618, an ejection pin 616, or any other type of pin. Here, the connecting end is a ball sized to fit in the socket 672. The ball and socket design allows the pin two degrees of freedom, as represented by the y and z axis of 676. Alternatively, other means of connecting the connecting end of the pin to the slideable pin carrier may also be used to provide two degrees of freedom to the pin. For example, instead of the connecting end of the pin 650 having the ball and the connecting end of the connector having a socket, the connecting end 652 of the pin may have a socket and the connecting end of the connector may have a ball. Also, other methods of connecting a pin to the pin carrier, such as a spring, may also be used to provide two or more degrees of freedom to the pin.

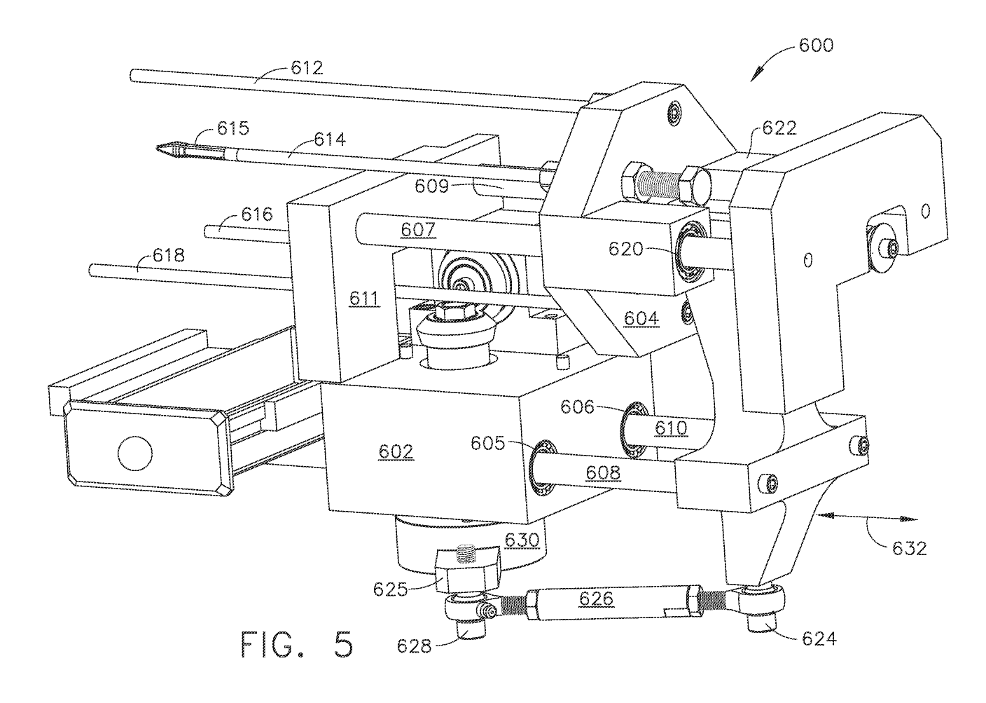

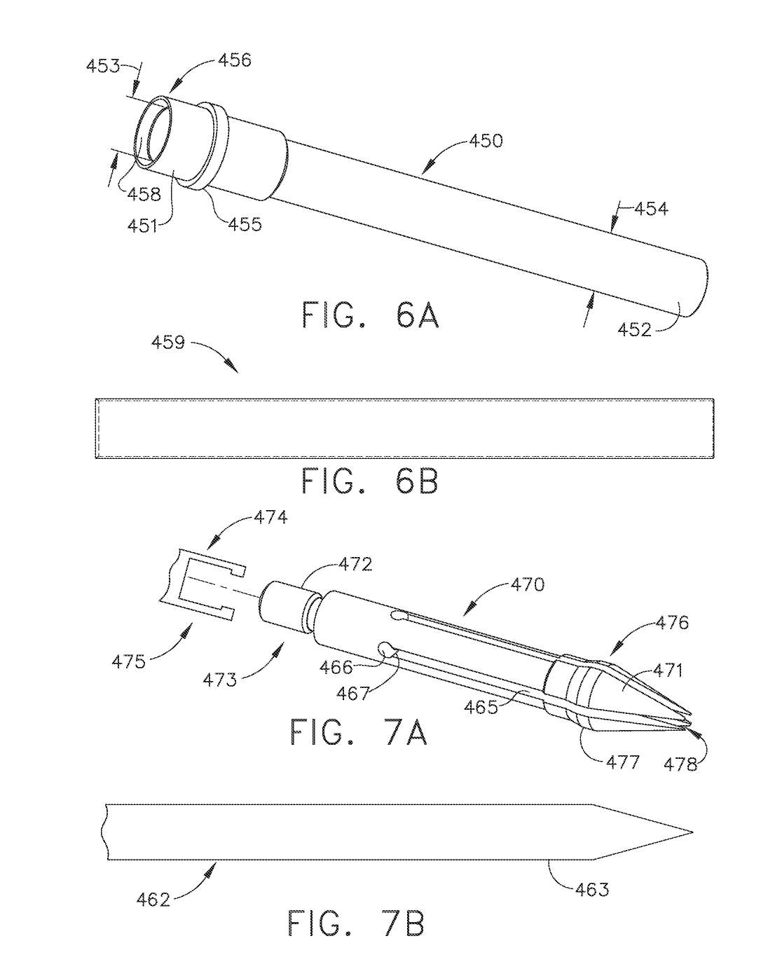

FIG. 6A illustrates a filling tube 450 having a first end 451, a second end 452, an inside diameter 453, and an outside diameter 454. Other shapes of tubes may be used as filling tubes, including square or octagonal shaped tubes. The first end 451 of the filling tube may have a shoulder 455 for securing the filling tube 450 to a filling tube holder (not shown). Alternatively, a filling tube may be secured to a filling tube holder (not shown) by other means, such as press fit, welded, or threaded connections. FIG. 6B shows an embodiment of the filling tube 459 without a shoulder that may be press fit or welded to a filling tube holder (not shown). The first end 451, may have a taper 458 from the first end 451 outside diameter 456 to the inside diameter 453 for receiving a guide head 470.

FIG. 7A illustrates an embodiment of a guide head 470. The guide head 470 has a distal end 471 and a proximal end 472 and is sized to fit within the inside diameter 453 of the filling tube 450. The proximal end 472 of the guide head 470 has fastening means 473 for attaching the guide head 470 to a pin 474 having a complimentary fastening means 475. The fastening means 474 and 475 can be a threaded connection, a press fit, or other methods known to those of ordinary skill in the art. Additionally, the guide head 470 and the pin 474 may be fabricated from a single piece of material. The distal end 471 of the guide head 470 has a substantially conical head 476. A largest diameter 477 of the conical head 476 is typically equal to or greater than the outer diameter 454 of the filling tube 450. Therefore, the conical head 476 is collapsible to enable it to pass through the filling tube 450 and exit out the second end 452 of the filling tube 450.

Various means may be used to provide a collapsible guide head. In the embodiment 470 shown in FIG. 7A, a plurality longitudinal slots 465 are cut from a tip 478 of the conical head 476 to a slot termination location 467. The slots typically terminate at a radius 466 to reduce stresses that the slots may induce into the guide head material and thereby prevent self propagation of the slots toward the proximal end 472 of the guide head 470. The guide head 470 may be made from a variety of materials, including plastics and metals. Typically, one may use a hardened steel, such as 01 steel hardened to 58-60 Rockwell C, for the guide head. Other means, such as a flexible rubber guide head, a polymer guide head, or an inflatable guide head may be used to produce a collapsible guide head.

FIG. 7B illustrates an embodiment of a pin 462 with guide head 463 in which the outside diameters of the pin 462 and the guide head 463 are equal to or less then the inside diameter 453 of the filling tube 450. In this embodiment, the guide head 463 does not need to collapse to pass through the filling tube 450.

FIG. 8A shows a filling tube holder 400 comprising a drum 401 having a first end 402 and a second end 403. The first end 402 of the drum 401 has a plurality of holes 404 and 405 for receiving a plurality of filling tubes 450. Other holes (not shown) for receiving filling tubes may also be disposed on the first end 402 of the drum 401.

This description describes filling tube 450 and the features in the drum 401 associated with filling tube 450. Other filling tubes mounted in the drum will typically be mounted in a similar manner, and the drum typically will have similar features for each of the other filling tubes. One method of attaching a filling tube 450 to a drum 401 is a clamping device 408 for clamping against the shoulder 455 on the first end 451 of the filling tube 450. Alternatively, other means for attaching the filling tubes to a filling tube holder may be used. For example, the filling tubes and the plurality of holes in the holder for receiving the filling tubes may be threaded. Also, the filling tubes may be threaded to receive a nut after passing through a hole in the drum. Additionally, other methods instead of a drum may be used for holding a plurality of tubes, for instance, the filling tubes may be mounted on a plate or on a belt.

Axially aligned with the filling tube hole 404 is a conical directing hole 411 having a proximal end 412 and a distal end 413. The distal end 413 of the cone shaped hole defines the larger diameter of the cone, and the diameter of the proximal end of the cone shaped hole is slightly larger than the outside diameter of a blank cigarette tube (discussed later).

FIG. 8B is a partial section view of the drum 401 having the filling tube 450 into which the guide head 470, typically attached to a pin (not shown), is passing. As the conical head 476 of the guide head 470 passes into the first end 451 of the filling tube 450, the filling tube 450 squeezes the guide head 470, thereby collapsing guide head 470 and allowing the largest diameter 477 of the guide head 470 to be less than the inside diameter 453 of the filling tube 450.

FIG. 8C is a partial section view of the drum 401 having the filling tube 450 through which the conical head 476 of the guide head 470, typically attached to a pin (not shown), has passed. The conical head 476, having passed through the second end 452 of the filling tube 450, can be observed in its relaxed state with the large diameter 477 of the guide head 470 now equal to or greater than the outside diameter 454 of the filling tube 450.

FIG. 8D illustrates a blank cigarette tube 425 being loaded onto the filling tube 450. The conical head 476 extends beyond the filling tube 450. The blank cigarette tube loader 700 (described later) induces a force on a filter end 426 of a blank cigarette tube 425, causing the blank cigarette tube 425 to move toward the conical head 476 of the guide head 470. In this illustration, an open end 427 of the blank cigarette tube 425 has been damaged, resulting in the normal circular shape of the end of the blank cigarette tube 425 becoming oblong. As the blank cigarette tube 425 moves toward the guide head 470, the proximal end 412 of the conical hole 411 in the drum 401 will operate to return the oblong open end 427 of the blank cigarette tube 425 to a more circular shape. The blank cigarette tube 425 continues through the conical hole 411, over the conical head 476, and then onto the filling tube 450.

FIG. 8E is similar to FIG. 8D, with the exception that the blank cigarette tube 425 has been filly inserted on the filling tube 450. Thereafter, the guide head 470 is removed from the filling tube 450 by withdrawing it out through the first end 451 of the filling tube 450. The filling tube 450 and blank cigarette tube 425 are then ready to receive the tobacco plug 265 prepared by the previously discussed tobacco compaction mechanism 100.

FIG. 8G illustrates an ejection pin 616 ejecting a completed cigarette tube 430, having been filled with a tobacco plug 265, from the filling tube 450.

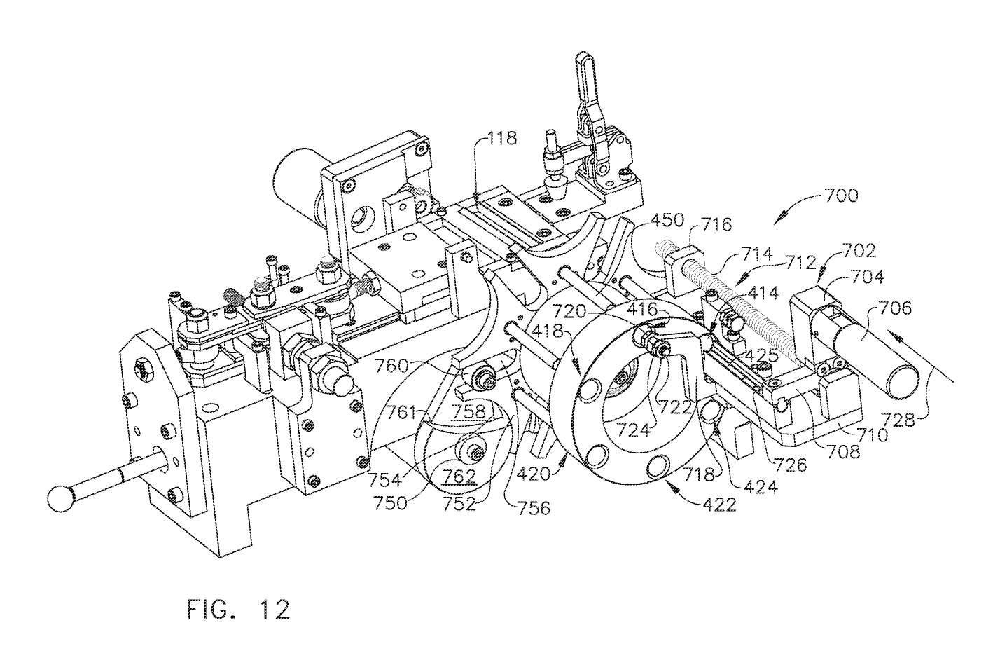

As shown in FIG. 12, the drum is driven and timed with a Geneva drive. Other types of driving and timing mechanisms may also be used. The Geneva drive translates the continuous rotary motion of a drum drive shaft 750 into intermittent rotary motion. The drum has a plurality of drum plates 752 with semicircular cutouts 754 and a slot 756 between each plate. A drive wheel 758 has a roller 760 with a diameter corresponding to the width of the slots 756 and a semicircular plate 762 with dimensions corresponding to the semicircular cutouts of the drum plates. As the drive wheel rotates, the roller 760 enters slot 756, thereby rotating the drum forward. As the drive wheel continues to rotate, the roller exits the slot, and a leading edge 761 of the semicircular plate 762 engages in the semicircular cutout 754, holding the drum in position until the pin engages the next slot and the process is repeated.

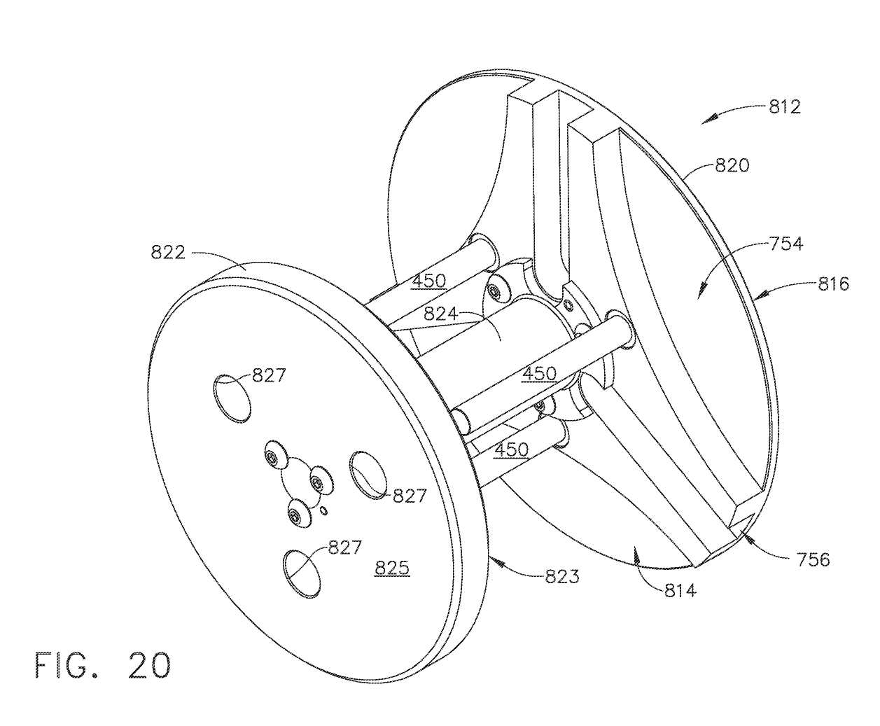

FIG. 20 shows another embodiment of a drum. Here a drum 812 is fabricated from a first plate 820 having a first face 814 and a second face 816, a second plate 822 having a first face 823 and a second face 825, and a support structure 824 for detachably affixing the first plate 820 to the second plate 822. Typically, the first face 814 of the first plate 820 faces the first face 823 of the second plate 822 when the plates are affixed together using the support structure 824. In this embodiment, integral with the first plate 820 is a driven mechanism of a Geneva drive mechanism for rotating the drum that includes semicircular cutouts 754 and outwardly opening slots 756 arranged alternatively in a circumferential direction. Alternatively, the second plate 822 may incorporate the semicircular cutouts and the outwardly opening slots of the driven mechanism. And in another embodiment, the driven mechanism with the semicircular cutouts and outwardly opening slots may be a separate plate that is affixed to the first plate, the second plate, or the support structure 824. The semicircular cutouts 754 and the slots 756 engage with a driving element 826 and a pin 828 of drive wheel 830. FIG. 21.

Referring back to FIG. 20, at least one filling tube 450 is affixed to the first face of the first plate. The second plate typically has at least one hole 827, typically a conical hole as described previously, axially aligned with the at least one filling tube. The filling tubes may be attached using the variety of methods described earlier. The second plate has a at least one cone shaped opening, as describe earlier, that is axially aligned with the at least one filling tube.

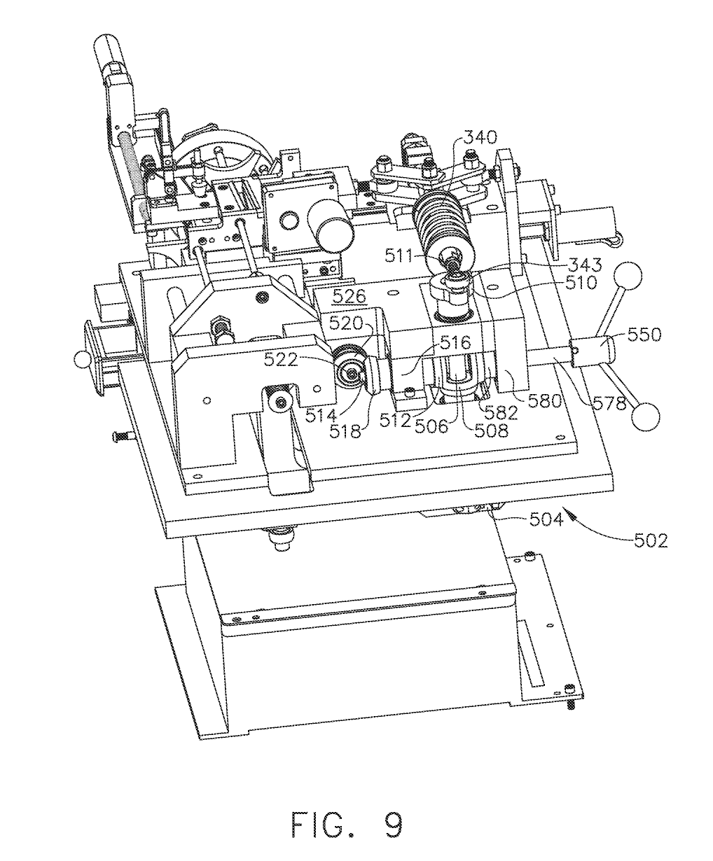

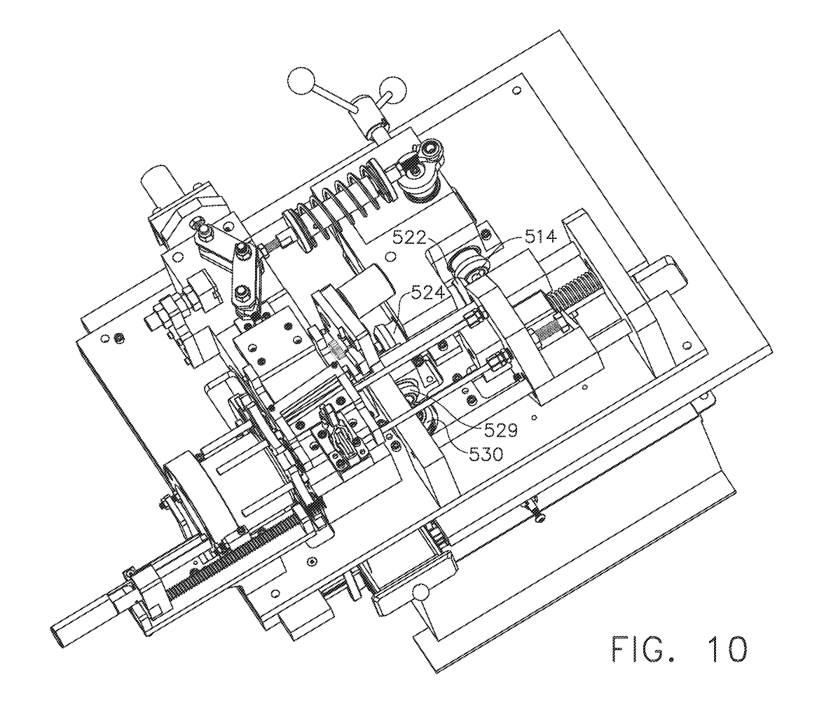

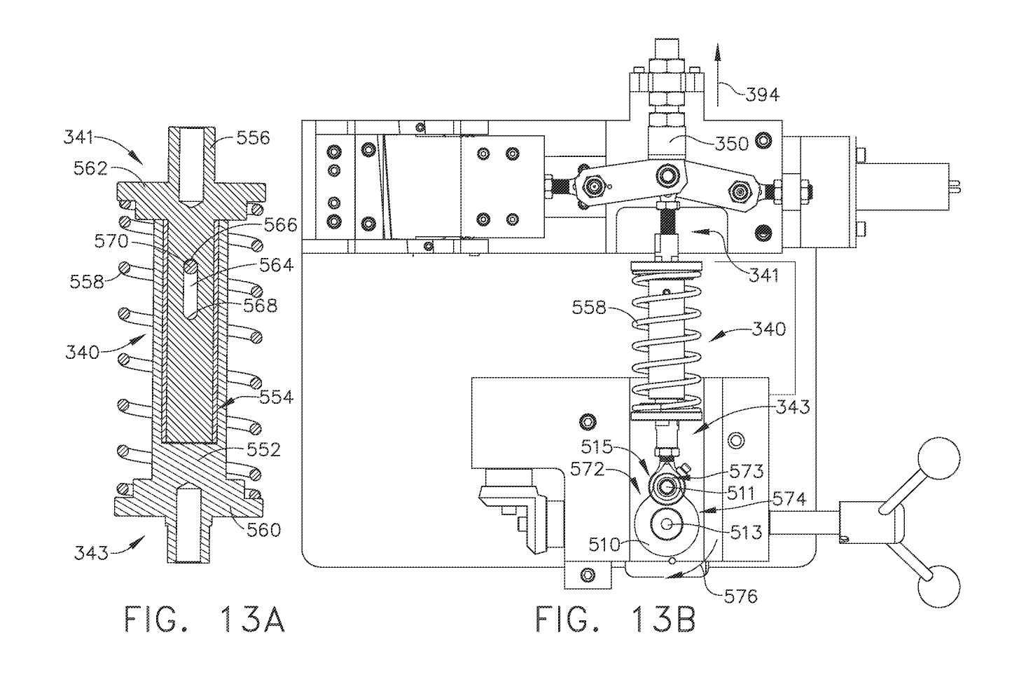

Referring now to FIG. 9, in operation, a motor 502 drives a gear reducer 504. An output shaft 506 from the gear reducer 504 has a first beveled gear 508 and a force input member wheel 510 mounted to it. As shown in FIG. 13B, the wheel 510 has a center 513 and a force input member arm 515 having a pin 511 that is offset a distance from the center of the wheel. The second end 343 of the force input member 340 is pivotable connected to the arm 515 by pin 511. The force input member 340 has a dwell mechanism that allows the force multiplying linkage to be at an over center position against the center stop 350 for a predetermined period of time during continued rotation of the wheel 510. One method of incorporating dwell is using a spring loaded force input member 340.

FIG. 13A shows a force input member 340 that is collapsible to allow a dwell time for the force multiplying linkage. The force input member 340 includes a first portion 552 with a receiving section 554 that slideably receives a second portion 556. A spring 558 is disposed between a first retainer 560 that is attached to the first portion 552 and a second retainer 562 that is attached to the second portion 556. The second portion 556 has a slot 564 having a first end 566 and a second end 568 sized to receive a pin 570 that is attached to the first portion 552. The force input member 340 shown in FIG. 13A is in the collapsed position, as indicated by the pin 570 resting against the first end 566 of the slot 564. When the force input member 340 is in the extended position, the pin 570 will rest against the second end 568 of the slot 564.

FIG. 13B shows the second end 343 of the force input member 340 connected to a pin 511 of the wheel 510 and the first end 341 of the force input arm 340 connected to the force multiplying linkage 300. As the wheel 510 rotates in the direction of arrow 576, the force input arm 340 is typically in the extended position until the pin 511 reaches a location 572. When the pin reaches the location 572, the force multiplying linkage hits the center stop 350, which prevents further travel of the force multiplying linkage in the direction of arrow 394. As the wheel 510 continues to rotate, the spring 558 is compressed. The force input arm 340 is in a compressed position, as shown in FIG. 13A, when the pin reaches a location 573. The spring remains compressed until the pin 511 of the wheel 510 reaches a location 574, by which time the force input member 340 has returned to its extended position. The collapsible force input member 340 allows the force multiplying linkage to remain, or dwell, in its position against the center stop 350 as the pin 511 moves from location 572 to location 574.

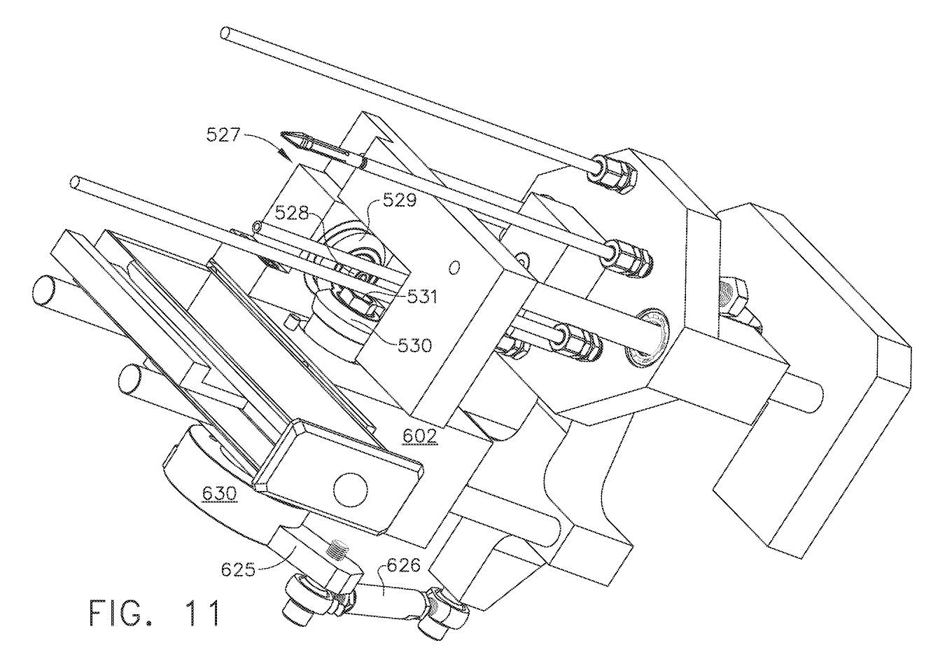

Referring to FIGS. 9 through 11, the first beveled gear 508 drives a second. beveled gear 512 that is attached to a shaft 514. The shaft 514 passes through shaft support 516 and has a third beveled gear 518 affixed to it opposite the second beveled gear 512. The third beveled gear 518 mates with a fourth beveled gear 520 that is mounted on a shaft 522. The shaft 522 passes through shaft support 526 and has a fifth beveled gear 524 affixed to it.

A sixth beveled gear 527 (not shown) meshes with the fifth beveled gear 524 and is affixed to one end of a shaft 528. A seventh beveled gear 529 is affixed to the shaft 528 opposite the beveled gear 527. An eighth beveled gear 530 meshes with the seventh beveled gear 529 and is affixed to a shaft 531 that passes through the pin carrier support 602 and has a wheel 630 with an arm 625 affixed to it opposite the sixth beveled gear 530. The arm 625 is connected to the slideable pin carrier 604 by an arm 626. The shaft 750 that drives the drive plate 758 of the Geneva drive mechanism has a beveled gear (not shown) also interacting with the sixth beveled gear 527.

Typically, one rotation of the output shaft 506 will result in one cigarette being made. Because, the output shaft typically rotates a full revolution without stopping and some mechanisms require dwell time in certain positions, various timing and dwell mechanisms may be used.

The cigarette making machine may also be manually driven by turning a hand wheel 550. A shaft 578 passes through support 580 and connects the hand heel 550 to a beveled gear 582. Instead of using the motor 502 to drive the cigarette making machine, an operator may use the hand wheel 550 to drive the beveled gear 582, which in turn operates the cigarette making machine.

Other methods may also be used to drive the cigarette making machine. For example, instead of the multiple beveled gears, one motor may be used to drive the wheel 510 that operates the force input member 340 to drive the force multiplying linkage 300, one motor may be used to drive the wheel 630 that drives the slideable pin carrier, and one motor may be used to drive the driven wheel of the Geneva gear, which drives the drum 401. When multiple motors are used instead of a single motor with beveled gears to drive and time the various operations, a timing mechanism is used to synchronize the motors. The timing mechanism may be components on a PCB, a PLC, or other various sensors or timers. Also, linear actuators may be used in place of at least some of the motors. For example, a linear actuator may be used in place of the wheel 510 and the force input member 340 to drive the force multiplying linkage and a linear actuator may be used in place of the wheel 630 and arm 626 to drive the slideable pin carrier. When linear actuators are used, a timing mechanism such as timers, components on a PCB, a PLC, or other various sensors or timers may be used to synchronize the linear actuators.

In an embodiment shown in FIG. 18, a motor 860 and a gear reducer 862 are used to drive a force input wheel 864 and a force input member arm 515. The motor 860 is reversible, which allows it to rotate in the direction of arrow 866 to extend the force multiplying linkage 300 and in the direction of arrow 868 to retract the force multiplying linkage 300. Sensors 870 and 872 are slideably mounted to supports 874 and 876, respectively. A sensor actuator 878 rotates with the force input wheel 864. Typically, the sensors 870 and 872 sense the sensor actuator 878 and send a corresponding signal to the cigarette machine controller. Thus, sensors alert the machine controller to the location of the force input wheel 864, and thereby the force multiplying linkage 300, and the machine controller can stop the rotation of the force input wheel 864 at the proper location.

The slideable pin carrier 604 is driven by an arm 886 that attaches to a wheel 884 that is operated by a motor 880 and a gear reducer 882. The motor 880 is reversible, which allows it to rotate in the direction of arrow 888 to move the slideable pin carrier 604 forward in the direction of arrow 892 and to rotate in the direction of arrow 890 to move the slideable pin carrier 604 back in the direction of arrow 894. Sensors 896 and 898 are slideably mounted on plates 900 and 902. Typically, the sensors 896 and 898 sense a sensor actuator 905 and send a corresponding signal to the cigarette machine controller. Thus, the sensors alert the machine controller to the location of the arm, and thereby the slideable pin carrier 604 and the machine controller can stop the rotation of the wheel 884 at the proper location.

The embodiment shown in FIG. 19A depicts a motor 904 and a gear reducer 906 for driving the wheel of the 830 (FIG. 21) of the Geneva gear mechanism. The motors for driving the force input member, the slideable pin carrier, the Geneva wheel, and the tobacco conveying device are controlled, timed, and synchronized by a controller. The controller may be a PCB and associated components, a microprocessor, a PLC, or any other mechanism programmed to properly time the operation of the cigarette making machine.

FIG. 12 shows the cigarette making machine having a blank cigarette tube loader 700. The blank cigarette tube loader 700 has a slideable body 702 comprising a body 704 with a handle 706 and a pusher 708. A blank cigarette tube loader base 710 carries a guide 712 on which the body 704 slides. A spring 714 operates against a stop 716 affixed to the blank cigarette tube loader base 710. A trough 726 is sized to receive a blank cigarette tube 425.

To operate the blank cigarette tube loader, a user places a blank cigarette tube 425 into the trough 726. Then, by pushing the handle 706 in the direction of arrow 728, the pusher 708 pushes the blank cigarette tube 425 onto the filling tube 450. The spring 714 assists the user in returning the handle 706 to the start position after loading a blank cigarette tube onto a filling tube.

An arm 718 having a cigarette stop 720 may also be affixed to the blank cigarette tube loader base 710. The cigarette stop prevents a blank cigarette tube 425 from being pushed off of the filling tube 450 when it is being loaded with a tobacco plug by the injection pin 612. The stop 720 may also be adjustable. For example, the stop 720 has a bolt 722 secured with a lock-nut 724 and passing through a threaded hole in the arm 718. The cigarette stop may be mounted to structures other than the arm 718 and still perform the same function.

To operate the cigarette making machine, a user pushes a button to cause the motor 502 to drive the slideable pin carrier 604 in the direction of arrow 619 (see FIG. 1) to a forward position shown so that the guide head 615, which guides the blank cigarette tube 425 onto the filling tube 450, of the guide pin 614 passes through the filling tube 450 as shown in FIGS. 8C and 8D. The user then inserts a blank cigarette tube 425 located at a station 414 (see FIG. 12) over a filling tube 450 mounted to a drum using the blank cigarette tube loader 700. Alternatively, the user could insert the blank cigarette tube 425 over the filling tube 450 manually without using the blank cigarette tube loader.

The cigarette making machine may also include a precompaction step. In the precompaction step, typically completed before the cigarette making cycle is started, the slideable plate 112 or slideable cleanout plate 113 is slid open as described previously to open the passage between the tobacco conveying device 200 and the discharge area 840. If the scoop sensor senses that the scoop is not in the rearward area 923 of the drawer 918, then the controller may prompt the user to open the drawer 918 and place the scoop 928 in the rearward area 973 of the drawer before starting the tobacco conveying device 200. The tobacco conveying device 200 is operated until tobacco is discharged through the chute into the scoop 928. The drawer 918 is opened, the scoop removed, and the tobacco in the scoop is placed into the input end 201 of the tobacco conveying device 200. The scoop is placed in the forward area 921 of the drawer 918 and the drawer is closed. With the scoop in the forward area when the final cleanout process, described later, is initiated after the cigarettes are made, excess tobacco will fall from the discharge area through the opening 926 in the drawer, and into the bin 912. After a number of production cycles, an authorized cigarette machine administrator will remove and clean the bin 912.

The user then presses a start button to begin a cigarette making cycle. First, slideable pin carrier 604 retracts in the direction of arrow 621 (see FIG. 1) and the tobacco conveying device 200 conveys a predetermined amount of tobacco to the compaction area 114. The rotating output shaft 506 drives the wheel 510, causing the force input member 340 to drive the force multiplying mechanism 300. The force multiplying mechanism 300 slides the slideable compacting plate 102 in the direction of 197, causing the compacting end 104 to compact the tobacco in the compaction area 114 into a compacted tobacco plug 265 in the compacted tobacco cavity 118.

While the tobacco compaction mechanism 100 is compacting the tobacco, the Geneva drive mechanism rotates the drum 401 to move the filling tube with the previously loaded blank cigarette tube to station 416 where it is axially aligned with the compacted tobacco plug 265 located in the compacted tobacco cavity 118 (see FIG. 12). Alternatively, the drum may be rotated before or after the tobacco compaction mechanism compacts the tobacco.

Referring also to FIG. 1, the slideable pin carrier 604 then moves forward in the direction of arrow 619, causing the injection pin 612, which is axially aligned with the compacted tobacco cavity 118, to inject the tobacco plug 265 into the filling tube 450. Because the injection pin 612 and the guide pin 614 with the guide head 615 are both attached to the slideable pin carrier 604, the guide head passes through the filling tube located at station 414 at the same time the injection pin 612 injects the tobacco plug 265. The motor then pauses to allow the user to load another blank cigarette tube onto the adjacent filling tube.

The user again pushes the start button after loading a blank cigarette tube onto the lilting tube located at station 414. The cycle of retracting the slideable pin carrier 604, conveying and compacting the tobacco, and injecting the tobacco then begins again. During this cycle, filling tube having the first loaded tube moves to location 418.

The machine pauses again to allow a user to load another blank cigarette tube onto a filling tube at location 414. Pressing the start button, another cycle is run. During this cycle, the first loaded tube moves to station 420 and a completed cigarette is ejected by the ejection pin 616 when the slideable pin carrier 604 moves in the direction of arrow 619. Alternatively, another cycle could be completed and the cigarette could be ejected at station 422.

During each cycle, the cleaning pin 617 is pushed through and cleans the filling tube located at station 424 when the slideable pin carrier 604 moves in the direction of arrow 619. Thus, the filling tube is cleaned before it moves forward to station 414, where it is loaded with a blank cigarette tube.

After making the cigarettes, a final cleanout process may be initiated. The scoop 928 is located in the forward area 921 of the drawer 918. During final cleanout, the slideable plate 112 or slideable cleanout plate 113 is retracted as described previously, the tobacco conveying device 200 is then operated to discharge excess tobacco through the compaction area 114, discharge area 840, chute 810, opening 926 and into the bin 912. Typically, the bin may not be accessible to a consumer making the cigarettes and is emptied by an authorized cigarette machine administrator. The operation steps and order thereof described herein are one example demonstration how a cigarette making machine may be operated to make cigarettes. The order of the steps may be altered, and steps may be added or omitted, without departing from the scope of this description or the spirit of the invention.

While the present invention has been illustrated by the description of embodiments thereof, and while the embodiments have been described in considerable detail, it is not intended to restrict or in any way limit the scope of the appended claims to such detail. Additional advantages and modifications will be readily apparent to those skilled in the art. The invention is therefore not limited to the specific details, representative apparatus and method, and illustrated examples shown and described. Accordingly, departures may be made from such details without departing from the scope or spirit of the invention.

What is claimed is:

1. A cigarette making machine tobacco cleanout mechanism comprising:
a. a slide support,
b. a slideable compacting plate disposed on the slide support,
c. a slideable cleanout plate located adjacent the slideable compacting plate, and
d. an engaging mechanism for removeably engaging the slideable compacting plate to the slideable cleanout plate, wherein the slideable cleanout plate is slid by the slideable compacting plate when the slideable compacting plate is slid while removeably engaged to the slideable cleanout plate.

2. The cigarette making machine tobacco cleanout mechanism according to claim 1 wherein the engaging mechanism is a solenoid with a central pin that projects from the solenoid into a receiving hole in the slideable cleanout plate.

3. The cigarette making machine tobacco cleanout mechanism according to claim 1 further comprising a slideable cleanout plate holding mechanism for holding the slideable cleanout plate in a closed position.

4. The cigarette making machine tobacco cleanout mechanism according to claim 1 further comprising a slideable cleanout plate sensor actuator affixed to the slideable cleanout plate.

5. The cigarette making machine tobacco cleanout mechanism according to claim 4 further comprising a first sensor mounted adjacent the slideable cleanout plate, wherein the first sensor interacts with the slideable cleanout plate sensor actuator when the slideable cleanout plate is in a first predetermined position.

6. The cigarette making machine tobacco cleanout mechanism according to claim 5 further comprising a second sensor mounted adjacent the slideable cleanout plate, wherein the second sensor interacts with the slideable cleanout plate sensor actuator when the slideable cleanout plate is in a second predetermined position.

7. The cigarette making machine tobacco cleanout mechanism according to claim 1 wherein the engaging mechanism is a solenoid with a central pin that projects from the solenoid into a receiving hole in the slideable cleanout plate, and further comprising a slideable cleanout plate sensor actuator affixed to the slideable cleanout plate, a first sensor mounted adjacent the slideable cleanout plate, and a second sensor mounted adjacent the slideable cleanout plate, wherein the first sensor interacts with the slideable cleanout plate sensor actuator when the slideable cleanout plate is in a first predetermined position and the second sensor interacts with the slideable cleanout plate sensor actuator when the slideable cleanout plate is in a second predetermined position.

8. A method of cleaning a cigarette making machine comprising:
a. removeably engaging a slideable compacting plate to a slideable cleanout plate,
b. retracting the slideable cleanout plate with the slideable compacting plate, thereby creating a passage between a tobacco conveying device and a discharge area,
c. operating the tobacco conveying device to discharge tobacco from the tobacco conveying device to the discharge area,
d. driving the slideable compacting plate forward, thereby extending the slideable cleanout plate to a closed position, and
e. disengaging the slideable compacting plate from the slideable cleanout plate.

9. The method of cleaning a cigarette making machine according to claim 8, further comprising the step of collecting the discharged tobacco.

10. A drum for holding at least one cigarette Idling tube comprising:
a. a first plate with a first face and a second face and having at least one filling tube disposed on the first face,
b. a second plate having a first face and a second face and defining at least one hole, the at least one hole axially aligned with the filling tube,
c. a support structure detachably affixing the first plate to the second plate whereby the first face of the first plate aces the first face of the second plate, and
d. a driven mechanism for rotating the drum communicating with the support structure and having semicircular cutouts and outwardly opening slots.

11. The drum for holding at least one cigarette filling tube according to claim 10, wherein the driven mechanism is affixed to the first plate.

12. The drum for holding at least one cigarette filling tube according to claim 10, wherein the driven mechanism is affixed to the second plate.

13. The drum for holding at least one cigarette filling tube according to claim 10, wherein the driven mechanism is integral with the first plate.

14. The drum for holding at least one cigarette filling tube according to claim 10, wherein the driven mechanism is integral with the second plate.

15. The drum for holding at least one cigarette filling tube according to claim 10, wherein the hole in the second plate is a conical hole having a first diameter at the first face and a second diameter at the second face, wherein the first diameter is less than the second diameter.

16. A cleanout container fir a cigarette making machine comprising:
a. a lower bin having an upper end, a lower end and bin sidewalls disposed therebetween, and a bin bottom enclosing the lower end of the bin,
b. a drawer slideably disposed above the lower bin, the drawer having a top, a bottom, and drawer sidewalls disposed therebetween, and a closing portion that at least partially closes the bottom of the drawer, and
c. a scoop having an upper end, a lower end, and scoop sidewalls disposed therebetween, and a bottom enclosing the lower end of the scoop, wherein the scoop is disposed in the top of the drawer.

17. The cleanout container according to claim 16 further comprising a scoop sensor interacting with the scoop.

18. The cleanout container according to claim 16 further comprising a sensor interacting with the drawer.

19. The cleanout container according to claim 16 wherein the scoop is removable.

20. The cleanout container according to claim 17 wherein the scoop is removable.
